(19) United States
(12) Patent Application Publication
(10) Pub. No.: US 2016/0125527 A1
(43) Pub. Date: May 5, 2016

(54) Financial Information Management System and User Interface

(71) Applicant: STANDARD & POOR'S FINANCIAL SERVICES LLC, New York, NY (US)

(72) Inventor: Svetla Marinova, New York, NY (US)

(21) Appl. No.: 14/896,648

(22) PCT Filed: Jun. 6, 2014
(86) PCT No.: PCT/US14/41336

§ 371 Date: Dec. 7, 2015

Related U.S. Application Data
(60) Provisional application No. 61/831,929, filed on Jun. 6, 2013.

(51) Int. Cl. G06Q 40/02; H04L 29/06

(52) U.S. Cl. CPC G06Q 40/02; H04L 63/10

(57) ABSTRACT

A computer-implemented method to generate a horizon view of a plurality of financial information objects is disclosed. The method includes the step of arranging, on a computer, the plurality of interactive financial information objects along a horizon carousel, wherein the financial information objects comprise at least one or more of market data, portfolio data, applications, and workspaces. The method further includes the step of displaying, on a display device of the computer, the horizon carousel and the financial information objects along a horizontal plane. The method further includes the step of generating, on the computer, an inspector window, wherein the inspector window displays, on the display device of the computer, additional information about an active interactive financial information object.

### PRIORITY CLAIM AND CROSS-REFERENCE TO RELATED APPLICATIONS

The present application claims priority to U.S. Provisional Patent Application Ser. No. 61/831,929, filed Jun. 6, 2013, which is hereby incorporated by reference in its entirety.

### TECHNICAL FIELD

The present invention relates to a financial information management and user interface enterprise system, and more particularly to methods and systems for displaying financial information and managing collaborative projects tailored to financial service professionals.

### BACKGROUND

Financial service professionals often gather financial and industry data from a variety of sources and use a variety of applications to create and/or modify data-based documents, e.g., reports, proposals, presentations, and models using the data. However, financial service professionals often have to import this data into a separate, second application in order to analyze it and create documents and other work product. The need for two separate systems creates problems with, for example, users importing, tracking, and collaborating on the desired information.

### SUMMARY OF THE INVENTION

The methods and systems of the present invention are directed to a computer platform that allows end users to both seamlessly collect and access financial information and work with that information in a collaborative environment. An interactive and intuitive financial information management system and user interface is disclosed that features a variety of financial applications. The applications may include content displays and interactive elements that help the user perform tasks particularly suited to the financial industry.

In some embodiments, the system includes a collaborative real-time document building application (which may be referred to as “SNAP”) specifically designed for financial services professionals. The SNAP application allows users to capture and collaborate on project-related information. For example, the SNAP application allows multiple team members to work on the same asset (e.g., a document, image, file, or conversation associated with a user or workspace) simultaneously in the financial information management system. Since some documents involve interaction among cross-functional team members located in different geographies, the application may be available as both a desktop application and a mobile application, and may allow a user to initiate documents remotely as well as review and annotate documents on a computing or mobile device. In particular, SNAP may include an asset viewer, which allows users to view and edit certain assets.

In some embodiments, the collaborative application allows users to share an idea with team members in a collaborative setting. In some embodiments, the application may allow a user to staff a project by selecting baseball cards. A “card” generally may refer to a container for an application and/or asset, and a baseball card is a specific type of card used for personnel profiles. In some embodiments, the application allows users to review and annotate documents on their computing or mobile device via the system.

The system may include an encrypted library where users can store their content, such as past presentations, research, and templates, and embellish that content with proprietary data coupled with the financial information management system or with third-party content. In some embodiments, the system provides each user with a library called “my library,” which is a personal library of assets that are defined by the user. Additionally, in some embodiments, the system may provide one or more workspace libraries that include a collection of assets that are available across workspaces. Based on permissions settings associated with each library and user, a user may upload content to the library, which may be encrypted, such as with AES 256-bit encryption. Additionally, the system may support an organizational library or an organizational library set, which includes a collection of assets available to an entire organization, such as templates, branding documents, etc.

In some embodiments, the financial information management system may also have a text-based search that incorporates natural language processing. In preferred embodiments, the text-based search is accessible through a global navigation element in the user interface of the system.

The financial information management system may include workspaces where teammates can organize and share project-specific assets with each other, and keep track of the progress of deliverables through a bulletin board and through notifications. In exemplary embodiments, a workspace refers to the container for project-related information showing associated users/members, assets, discussions, etc. In some embodiments, a workspace, and all of the content contained therein may be secured by encryption. In some embodiments, the workspace interface, presented through a graphical user interface displaying on the screen of a computing device, allows a user to organize and manage documents in the workspace using an input device, such as a mouse, pointer, finger, or through voice recognition. In some embodiments, the workspace may have a workspace canvas, which is the visual area of a workspace that contains assets, user icons, user bubbles, etc. to support user collaboration.

Workspaces may provide collaborative functionalities to users of the system. For example, the workspace may allow users to track projects and manage projects, such as by allowing a user to create a team, assign a task, set deadlines, and schedule events through a bulletin board, all of which may be assessable to other members of the workspace. A workspace library may include proprietary data associated with the financial information management system platform, such as proprietary financial data, and users may be able to couple content, such as financial data, to a specific project in the workspace. Additionally, a user may couple and/or import content from external sources to the workspace and/or add such content to a workspace library. In some embodiments, a user may create an asset from any content and add it to a workspace, such as via a comment or a chat conversation.

The system's interface may display, on a screen of a computing device, a powerful visual framework to help users better orient themselves on the system and get to an application or a specific document faster. The visual framework may be referred to as a “horizon” or “horizon view,” which is a stylized and interactive view of applications, workspaces, market data, and other information shown at the launch of the financial information management system. In exemplary embodiments, the horizon view includes a horizon carousel that displays a graphical, interactive list of available system elements. In some embodiments, a horizon menu allows a user to alter the display of the horizon carousel, such as by sorting and/or filtering the list of available system elements. In exemplary embodiments, when an item is selected or focused on in the horizon view, an inspector window, or a detail panel showing information for the focused object, will appear.

In some embodiments, the system has an interactive landing page that displays the latest financial developments or other news of the day to a user based on the user's custom list of important or followed developments, companies, news events, etc.

In some embodiments, the system includes a powerbar tool. The powerbar tool is a primary navigation element in the financial information management system that provides access to workspaces, applications, and other elements of the system. For example, the powerbar may include categories, including, for example, favorites, markets, news recent activity, workspaces, applications, and contacts. In exemplary embodiments, the powerbar tool may pin a user's favorite application, thereby providing faster navigation to that application. In exemplary embodiments, the financial information management system maintains a recent activity log of timestamps and other information relating to a user's activities throughout the system. In some embodiments, the recent activity is displayed in the powerbar.

In some embodiments, the system includes a card navigational tool that includes a visual history of all applications and projects that a user has worked on. The card navigational tool may be referred to as a card pipeline, which refers to a horizontally scrolling area that displays cards. Additionally, there may be an interactive thumbnail view of the card pipeline called the card pipeline navigator. The card pipeline may display a card set, which includes one or more cards that may be linked to an asset. Additionally, there may be child cards in the card set that are dependent on a parent card for its content. In exemplary embodiments, the currently focused card in the card pipeline, or the “active card,” is always fully in view. In some embodiments, cards may be nested inside of other cards, which may be displayed in a stack.

A card may be, for example, the logical grouping and visual display of related applications (in different states) and information in the form of a card. In some embodiments, the cards display information in such a way that all of the information presented on a card is visible in one view, and consequently there is need for scrolling to view additional information.

The system may incorporate various word/data processing software and packages. For example, the system may allow users to access Microsoft Webapps Word, Powerpoint, and Excel so that a user can process documents and data within the system. For example, a power point presentation may be presented on the system interface via an asset viewer. The asset viewer may be configured to display a slide and may allow a user to navigate between pages of the presentation. In this context, examples of an asset may include a power point presentation, a document, a spreadsheet, etc.

In some embodiments, the financial information management system may include a global navigation, which is an area of the interface display that displays global, persistent actions such as a global search, login, help, notifications menu, etc.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements.

FIG. 1 is a block diagram depicting the physical architecture of a financial information management system, in accordance with exemplary embodiments of the present invention.

FIG. 2 is a block diagram showing the communication links of a financial information management system, in accordance with exemplary embodiments of the present invention.

FIG. 3a is a block diagram depicting a market horizon displayed in a graphical user interface of a financial information management system, in accordance with exemplary embodiments of the present invention.

FIG. 3b is a block diagram depicting an application horizon displayed in a graphical user interface of a financial information management system, in accordance with exemplary embodiments of the present invention.

FIG. 3c is a block diagram depicting a workspace horizon displayed in a graphical user interface of a financial information management system, in accordance with exemplary embodiments of the present invention.

FIG. 4a is a block diagram depicting a circle view of team members and assets in a collaborative workspace displayed in a graphical user interface of a financial information management system, in accordance with exemplary embodiments of the present invention.

FIG. 4b is a block diagram depicting a list view of team members and assets in a collaborative workspace displayed in a graphical user interface of a financial information management system, in accordance with exemplary embodiments of the present invention.

FIG. 5a is flow diagram depicting a method of creating a new asset in a financial information management system, in accordance with exemplary embodiments of the present invention.

FIG. 5b is a flow diagram depicting a method of presenting an asset in a financial information management system, in accordance with exemplary embodiments of the present invention.

FIG. 5c is a flow diagram depicting a method of editing an asset in a financial information management system, in accordance with exemplary embodiments of the present invention.

FIG. 6 is a block diagram depicting a display window in a graphical user interface with permission controls for a collaborative workspace in a financial information management system, in accordance with exemplary embodiments of the present invention.

FIG. 7 is a block diagram depicting a forum in a workspace in a graphical user interface of a financial information management system, in accordance with exemplary embodiments of the present invention.

FIG. 8 is a block diagram depicting an add-to-forum window in a graphical user interface of a financial information management system, in accordance with exemplary embodiments of the present invention.

FIG. 9 is a block diagram depicting a summary view of a workspace in a graphical user interface of a financial information management system, in accordance with exemplary embodiments of the present invention.

FIG. 10 is a block diagram depicting a card pipeline navigator displayed in a graphical user interface of a financial information management system, in accordance with exemplary embodiments of the present invention.

FIG. 11 is a block diagram depicting a powerbar global navigation tool in a graphical user interface of a financial information management system, in accordance with exemplary embodiments of the present invention.

FIG. 12a is a block diagram depicting a global search in a graphical user interface of a financial information management system, in accordance with exemplary embodiments of the present invention.

FIG. 12b is a block diagram depicting results from a global search in a graphical user interface of a financial information management system, in accordance with exemplary embodiments of the present invention.

FIG. 13 is a block diagram depicting notifications in a graphical user interface of a financial information management system, in accordance with exemplary embodiments of the present invention.

FIG. 14 is a block diagram depicting a workspace framework in a graphical user interface of a financial information management system, in accordance with exemplary embodiments of the present invention.

FIG. 15 is a block diagram depicting cards in a graphical user interface of a financial information management system, in accordance with exemplary embodiments of the present invention.

FIG. 16a is a graphical workspace display depicting a card with a public company profile, in accordance with exemplary embodiments of the present invention.

FIG. 16b is a graphical workspace display depicting a portfolio card with a helios display, in accordance with exemplary embodiments of the present invention.

FIG. 17 is a graphical workspace display depicting a commenting feature for an asset, in accordance with exemplary embodiments of the present invention.

FIG. 18 is a graphical workspace display depicting the importation of an asset, in accordance with exemplary embodiments of the present invention.

FIG. 19 is a graphical workspace display depicting a visual trace feature of a financial information management system, in accordance with exemplary embodiments of the present invention.

FIG. 20 is a block diagram of a logical data model for a financial information management system, in accordance with exemplary embodiments of the present invention.

FIG. 21 is a block diagram depicting a computing device in accordance with exemplary embodiments of the present invention.

### DETAILED DESCRIPTION

The methods and systems described herein are directed to a computer platform that provides an intuitive interface that allows end users to collect and access financial information and work with that information in a collaborative environment.

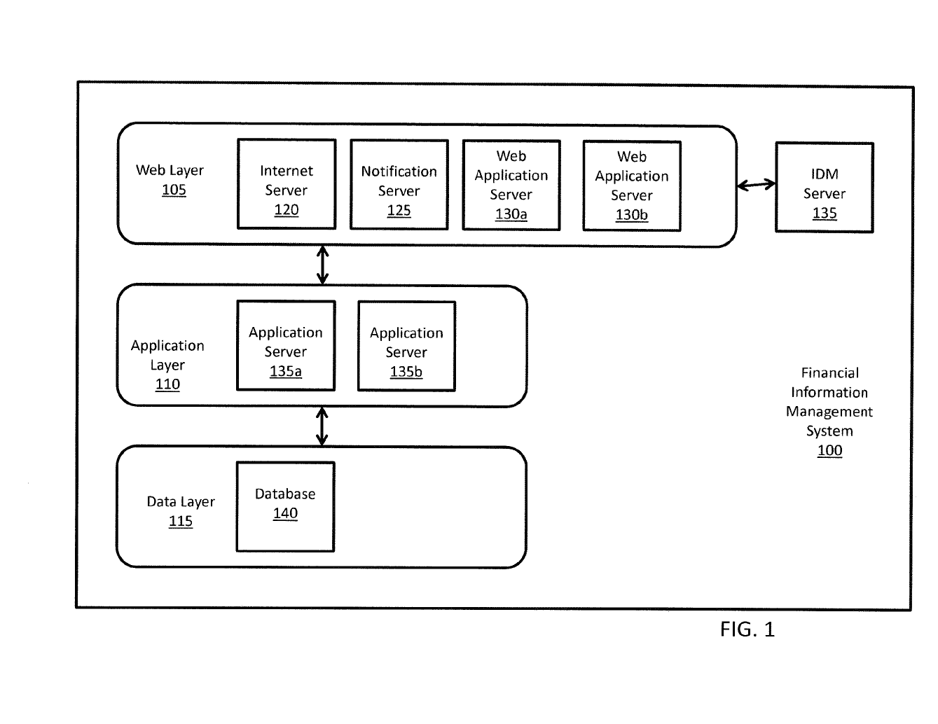

FIG. 1 is a block diagram depicting the physical architecture of a financial information management system, according to exemplary embodiments of the present invention. The financial information management system 100 may include a web layer 105 that handles the front end of the system, e.g., the user interface, and an application layer 110 and data layer 115 that support the backend of the system.

The web layer 105 may include, for example, an Internet sever 120, notification server 125, one or more web application servers 130a,b, and a domain controller server (IDM) 135. In some embodiments, Internet server 120 may be a Microsoft Internet Information Server (IIS) running a Windows operating system, or may be, for example, an Apache, Sun Microsystems, or O'Reilly sever. The Internet server 120 may include a set of program code for building and administering a website. Such a website may provide users with web-based applications that access one or more databases. The notification server 125 may provide notifications to be displayed in the front-facing interface to web-users. The notification server 125 may be, for example, a Linux Kaazing server. Web application server 130a may provide a web application platform, for example, Microsoft SharePoint, that supports content/document management and collaboration functionalities. A second web application server 130b may provide additional web applications for creating documents and other content. For example, in some embodiments, web application server 130b may be a Microsoft Windows Web Application server that supports Microsoft web applications, including Microsoft PowerPoint, Excel, Word, etc. Additionally, one or more domain controller servers (IDM) 135 may be used to authenticate a user, for example, by responding to a security authentication requests in response to a user logging in or requesting access to an application or content.

The application layer 110 may include, for example, one or more application servers 135a,b with middleware that serve as the liaison between the web layer 105 and the backend data layer 115 and database 140. In some embodiments, application server 135a is one or more Microsoft Windows application servers and application server 135b is one or more application Linux servers. In some embodiments the application servers 135a,b may be responsible for displaying data and images in the web layer 105 to a user in a human-recognizable format, and interfaces with the underlying data layer 115 to access and process information which ultimately may be sent back to a user.

The data layer 115 may include one or more data storage devices, including, for example, a database 140. In some embodiments, database 140 may be a Microsoft Windows SQL server. Application layer 110 may directly interface with the data layer 115 in order to retrieve and store information in one or more databases 140.

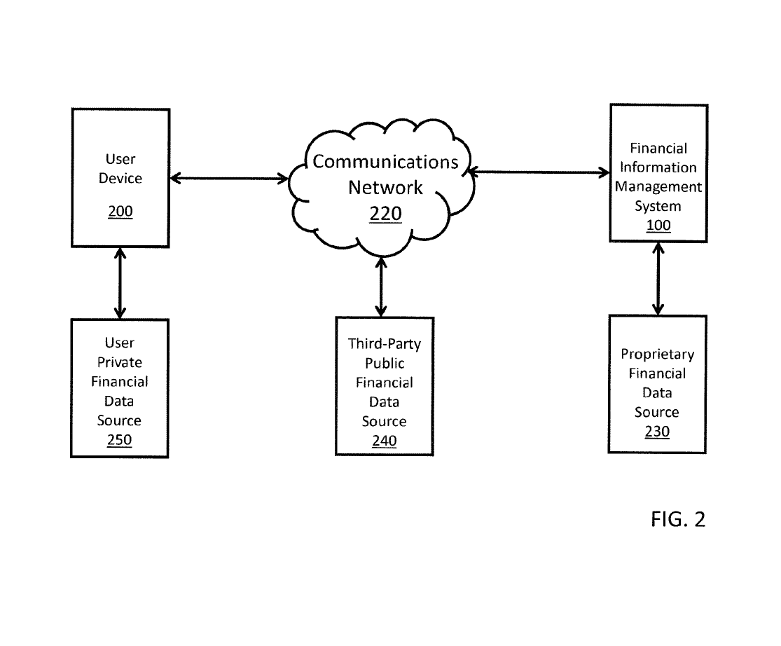

FIG. 2 is a block diagram showing the communication links of a financial information management system, in accordance with exemplary embodiments of the present invention. In exemplary embodiments, financial information management system 100 communicates with one or more user devices 200 through a communications network 220, such as the Internet. In exemplary embodiments, user device 200 may be a personal computing device, such as a laptop or desktop computer, and/or a mobile device, such as a cell phone or tablet. In some embodiments, the financial information management system 100 has secure access to a proprietary financial data source 230. The proprietary financial data source 230 may be, for example, a database 140 coupled to the financial information management system 100 through a data layer 115. In some embodiments, the financial information management system 100 may be electronically coupled to the proprietary data source 230 over a secure connection through a communications network 220. In some embodiments, financial information management system 100 may access a third-party's publicly available financial data source 240 through communications network 220. Additionally, in some embodiments, user device 200 may be electronically connected to a user's private financial data source 250, such as an electronic financial portfolio associated with a user. Accordingly, in some embodiments, financial information management system may access a proprietary financial data source 230 or third-party financial 240 directly, such as through communications network 220, or may access a user's private financial data source 250 through user device 200 and communications network 220.

In exemplary embodiments, a user accesses the financial information management system 100 web layer 105 by entering a URL into a graphical user interface (“GUI”) of user device 200 running a web browser. In exemplary embodiments, the GUI will present the user with a log-in screen and a prompt for the user to enter log-in credentials such as, for example, a username and password. In some embodiments, authentication of a user may be accomplished using IDM server 135.

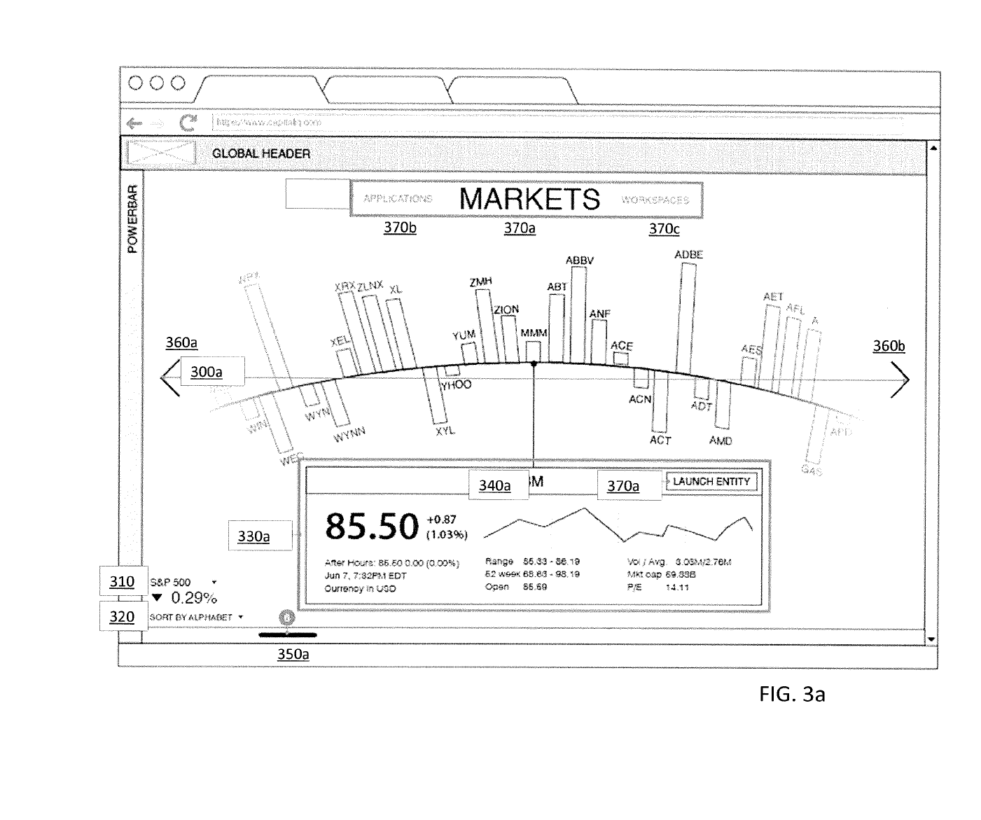

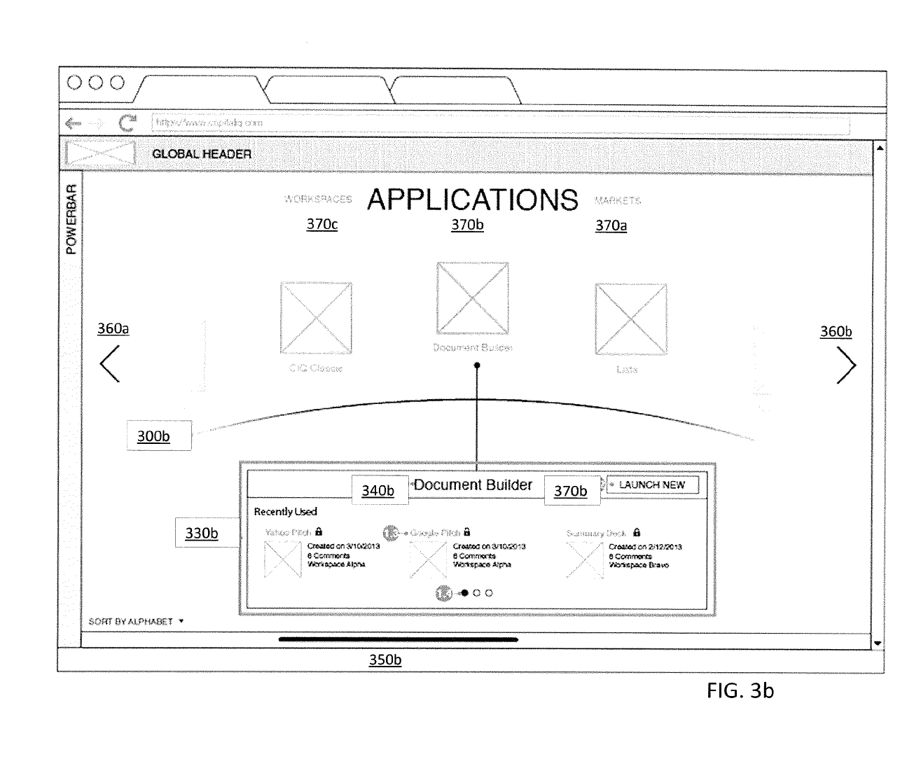

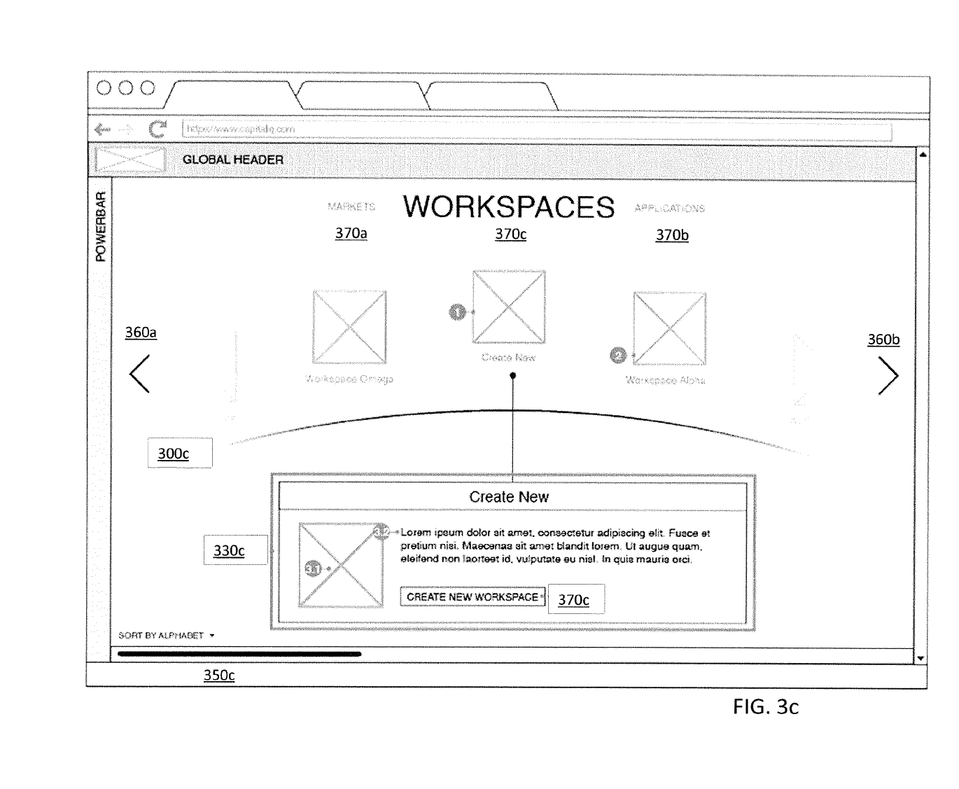

In exemplary embodiments, once a user is authenticated, the financial information management system 100 generates unique graphical displays and navigational tools in the GUI of user device 200. The GUI may display visual representations of several categories of information, including workspaces, markets, and applications graphically along a continuous line, referenced herein as the horizon and described in further detail below with reference to FIGS. 3a-c.

FIG. 3a is a block diagram depicting a market horizon displayed in a graphical user interface of a financial information management system, in accordance with exemplary embodiments of the present invention. In exemplary embodiments, the market horizon is the “landing page” to which a user is directed to after authentication. The market horizon is displayed in a GUI on a display screen of user device 200, and depicts a plurality of interactive financial information to a user positioned along a horizontal plane 300a. In some embodiments, the market horizon may provide a complete market overview for the day, including highlights of the best and worst performers, and companies currently in the news. Users may arrange the items on the market horizon according to customizations, for example, by clicking on sorting tab or button element 320 (“sort by alphabet”), and the items displayed in the horizon may be customized with a specific portfolio or something as general as the S&P 500 by clicking on a display tab or button element 310. For example, FIG. 3a depicts a market horizon displaying financial information for the S&P 500 sorted alphabetically.

A user may click on a specific piece of financial information displayed on the market horizon display, such as a market and/or information for a group of investment vehicles (e.g., securities, bonds, etc.), and an inspector window 330a may pop up, e.g., below the horizon 300a as shown in FIG. 3a, to display more information about that item 340a (“3M”). For example, current performance, including pricing information and graphs, may be listed under each item. Additionally, a user may select the launch entity button 370a in order to view additional information and/or perform additional analysis concerning an item.

The horizon display may be horizontally scrollable, e.g., as a horizon carousel, so that a user can view other components of the horizon. For example, a user may, by using a mouse or other input device, drag the horizon to the left or to the right using a scrollbar 350a, or by clicking or selecting arrows 360a,b that will move the display left and right. For example, clicking or touching an arrow 360a,b will move linearly through the items in the horizon display. Each click will navigate to the next item listed. Furthermore, clicking/touching and holding on either arrow 360a,b will continually navigate through the items. This behavior should exhibit some sense of physics, for example, holding longer will result in faster and faster navigation. An inspector window 330a may pop up for the item located at a particular point on the horizon, e.g., the center.

In some embodiments, the market horizon display may automatically navigate to different markets and financial items based on incoming, real-time news events. For example, if a current important event pertains to a certain item, the market horizon display may automatically navigate to the location of that item on the horizon 300a, and the news event, or a snippet, may be displayed in the inspector window 330a.

In exemplary embodiments, there may be a portfolio monitor representation in the market horizon where a user can visually inspect the performance of a portfolio. Uses of shape and color may portray meaningful information with respect to portfolio performance. A further graphical symbol may provide a comparison between the items that is quickly discernible. For example, a bar extending in a certain direction from the horizon 300a may indicate positive (e.g., a bar extending above the horizon 300a) or negative (e.g., a bar extending below the horizon 300a) performance with the length of the bar being indicative of the magnitude of the positive or negative performance. In some embodiments, the color of the bar may be selected to indicate positive or negative performance.

In exemplary embodiments, a user may navigate to the application horizon or workspace horizon displays by selecting the appropriate button, link, or tab 370a-c at the upper portion of the horizon market display. For example, if a user selects button/tab/link 370b, the graphical user interface will display the application horizon depicted in FIG. 3b.

FIG. 3b is a block diagram depicting an application horizon displayed in a graphical user interface of a financial information management system, in accordance with exemplary embodiments of the present invention. In some embodiments, each application may be represented by a distinctive image, such as a cube with icons. In exemplary embodiments, each application is depicted along a horizontal horizon 300b. As described above with reference to FIG. 3a and the market horizon, a user may navigate through the different applications along the horizon 300b using the scroll bar 350b or arrows 360a,b. If an application is selected, an inspector window 330b may pop up to display informational items about the selected application. For example, if a user selects a “document builder” application off the horizon 300b—which is used to create documents and other assets, described in further detail below—the inspector window 330b may display the name of the application 340b (“Document Builder), and other information such as recently used documents (“Yahoo Pitch,” “Google Pitch,” and “Summary Deck”). Additionally, the inspector window 330b may display a button 370b to instantiate a new document/Asset.

In exemplary embodiments, for all users by default, all the applications a user has access to may be displayed on horizon 300b. By default, the applications may also be sorted by the most recently used. For first time users who have not yet used any application, the default sort may be alphabetical. A user may navigate to the market horizon or workspace horizon displays by selecting the appropriate button, link, or tab 370a-c at the upper portion of the application horizon display. For example, if a user selects button/tab/link 370c, the graphical user interface will display the workspace horizon depicted in FIG. 3c.

FIG. 3c is a block diagram depicting a workspace horizon displayed in a graphical user interface of a financial information management system, in accordance with exemplary embodiments of the present invention. In the workspace horizon display, a user may be able to navigate through existing workspaces that are depicted along the horizon 300c. A user may navigate along the horizontal direction of horizon 300c using scrollbar 350c or arrows 360a,b, as described above.

Each workspace may be depicted by a unique icon or graphic. A user may also be able to select an existing workspace depicted on horizon 300c, and an inspector window 330c may display information about that existing workspace. This information may include a list of team members, team page controls, workspace status, workspace assets, workspace updates, workspace deadline, and forum posts. In other instances, selecting a workspace will automatically open that workspace so that it may be displayed to the user.

A user may also create a new workspace in the workspace horizon by selecting the “Create New” workspace icon. Selecting the “Create New” workspace icon will open inspector window 330c. The inspector window 330c may allow a user to set details about the new workspace. The user may then create and open the new workspace by selecting the “Create a New Workspace” button/link 370c.

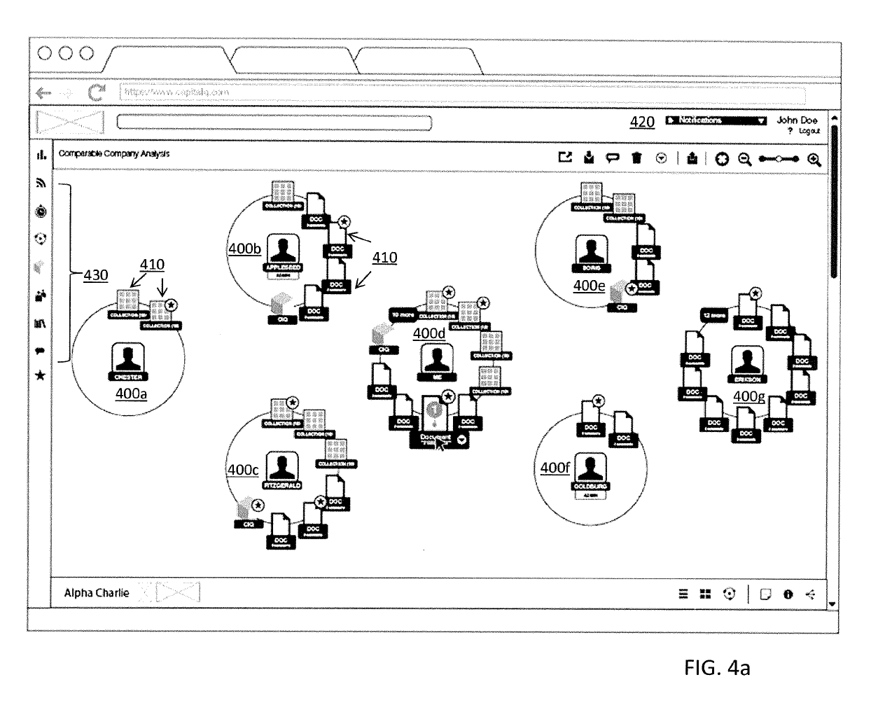

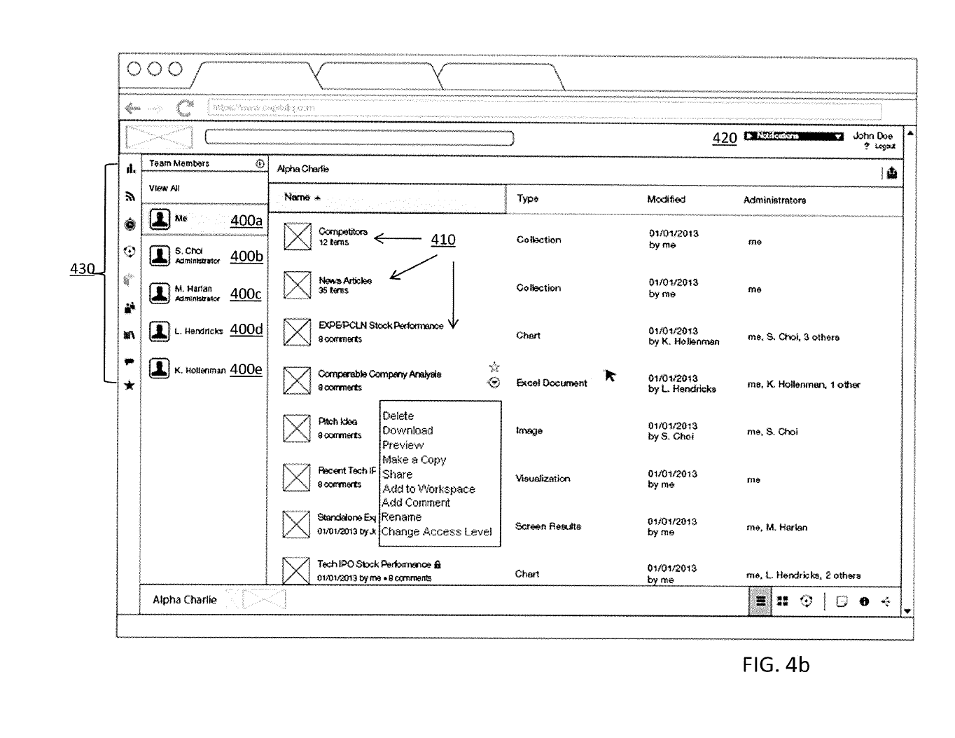

FIG. 4a is a block diagram depicting a circle view of team members and assets in a collaborative workspace displayed in a graphical user interface of a financial information management system. FIG. 4b is a block diagram depicting a list view of team members and assets in a collaborative workspace displayed in a graphical user interface of a financial information management system, in accordance with exemplary embodiments of the present invention. Generally, FIGS. 4a and 4b depict how a Workspace may be displayed in the graphical user interface of a financial information management system.

In some embodiments, a workspace may be displayed in a circle view, as depicted in FIG. 4a, where team members 400a-g of a workspace are displayed as orbits with corresponding documents and other assets 410 surrounding each team member in a circle. In the workspace circle view, current members are displayed in orbits around their associated assets. Each orbit (or bubble or circle) displays a member's name, photo, and associated assets. In other embodiments, such as depicted in FIG. 4b, team members 400a-e of a Workspace are displayed in a list, and selection of a team member will display a the team member's documents and/or assets 410 in list form.

In some embodiments, a user may open an asset 410, or document, from the workspace, by, for example, using an input device, such as a mouse, to select an asset 410 by touching it. For example, using a mouse input, a user may hover the mouse icon over an asset 410 and double click the asset 410 to open it. The user may then view the asset in an Asset viewer, edit the asset, add content to the asset, post a comment to the asset, and otherwise collaborate on the asset with other members of the team in the Workspace. If a user adds a comment to an asset 410, a notification may be sent to the owner of the asset 410, or to the team. In exemplary embodiments, a notifications indicator 420 would appear in the workspace window and indicate to the user, using, for example, colors and icons, that a notification is waiting. In some embodiments, a user may share an asset 410 with another user by conventionally dragging and dropping the asset 410 into the user's circle (or list) in a workspace.

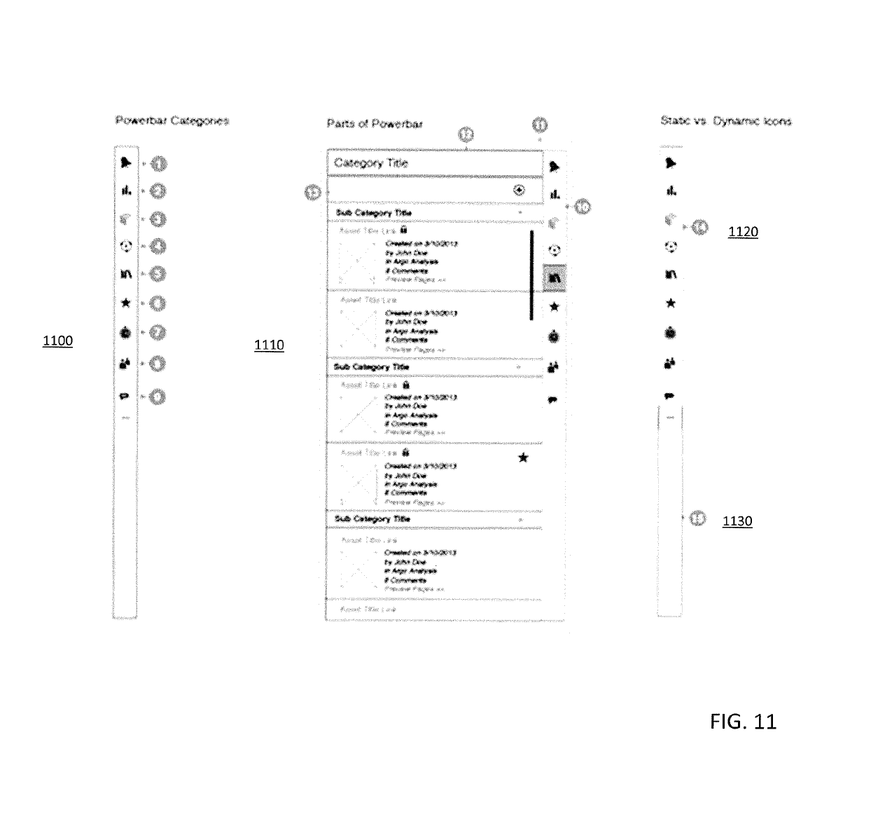

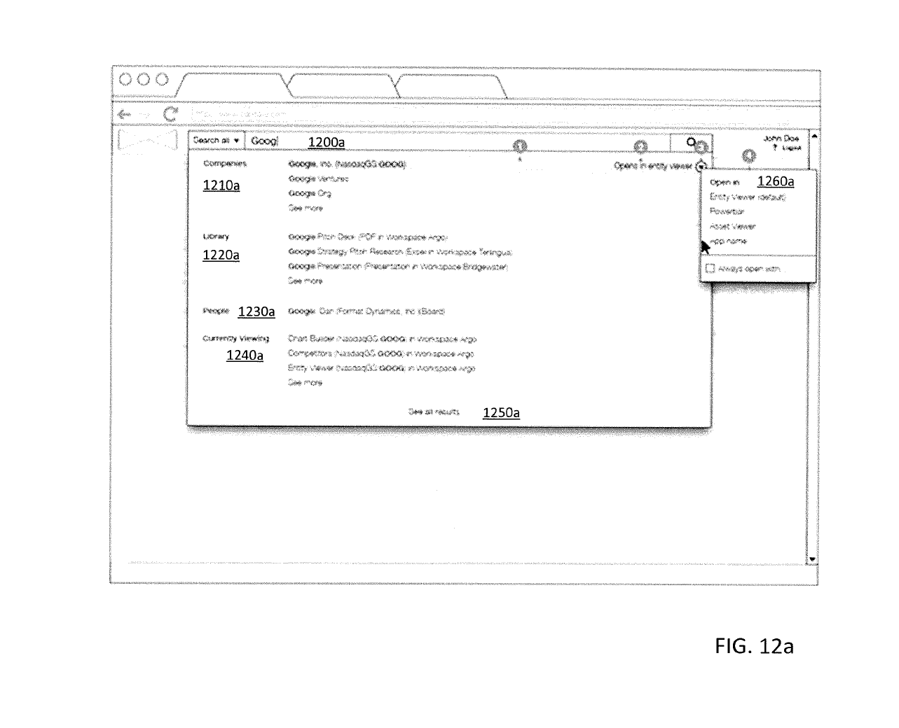

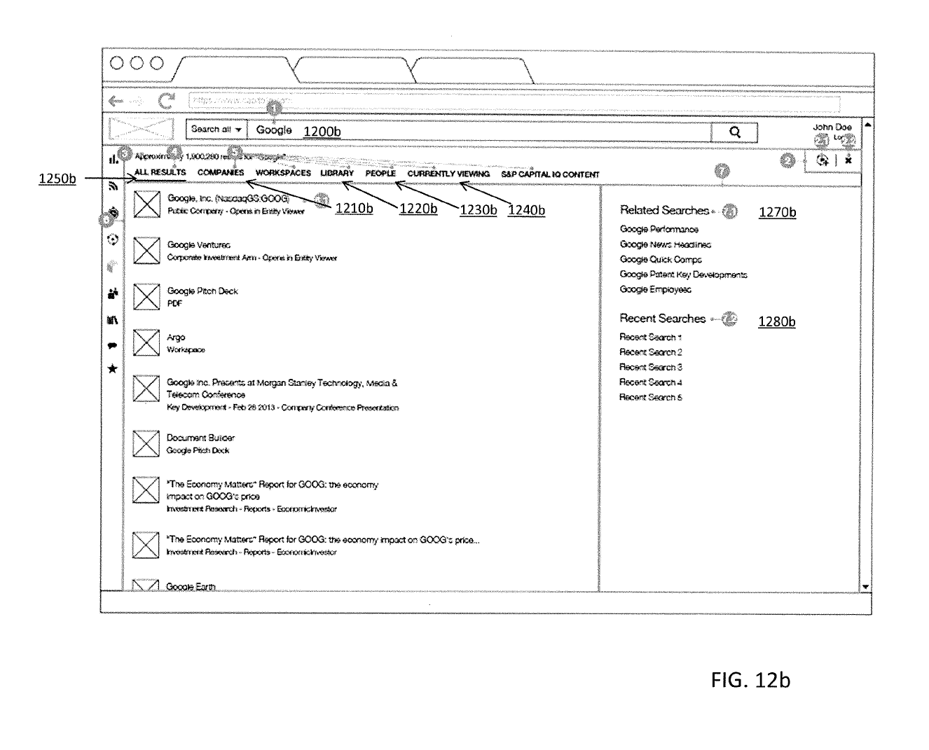

In exemplary embodiments, the landing pages depicted in FIGS. 3a-c include additional navigational elements, including a powerbar and a global header. The powerbar is described in further detail below in connection with FIG. 11, and a global search feature of the global header is described in further detail below in connection with FIGS. 12a-b.

In exemplary embodiments, users may have different capabilities to view and/or edit an asset based on their role. In some embodiments, a user may be designated an admin user role with the capability to delete a comment, post, or thread relating to an asset. In other embodiments, a user may be an asset creator, and may assign view and/or view/edit permissions to other users. In some embodiments, the asset creator may be designated as an administrator. Additionally, in some embodiments, a user may be able to download an asset from a workspace on the system to his or her desktop computer, tablet, phone, or other computing device.

In some embodiments, depending on whether a user has admin or edit and/or view permissions, a user may delete, rename, grant access rights to, assign a color label to, re-locate, or add/remove tags from an asset. If a user does not have appropriate permission/access to perform a certain modification on an asset, such as delete, the asset may, for example, appear as a grayed out box. An asset creator, for example, may set permission/access restrictions for each team member in the workspace, as depicted in FIG. 3a. In some embodiments, rather than creating a new document or asset in the workspace, a user may upload or import an asset into a workspace.

In some embodiments, a system user may copy, import, and/or share assets in a workspace. A user may have other options with respect to assets, such as changing an asset to another file type and setting permissions to who can view/edit an asset. In some embodiments, a user, such as an administrative user, may be able to populate and manage an organizational library with assets so that users across other workspaces have access to a set of assets. Such an organizational library may be searchable, for example, using natural language processing. In other embodiments, a system user may be able to populate and manage a personal library of assets. In some embodiments, the assets in a user's personal library may be synchronized to a specific location on a user's computer or network outside of the system platform. In particular, synchronization refers to the process of updating workspace content before or after going into offline mode, and may require the use of a plug-in. Additionally, a user can designate one or more documents or assets that can be edited in a document builder as a template. The template may be organization-specific or workspace-specific.

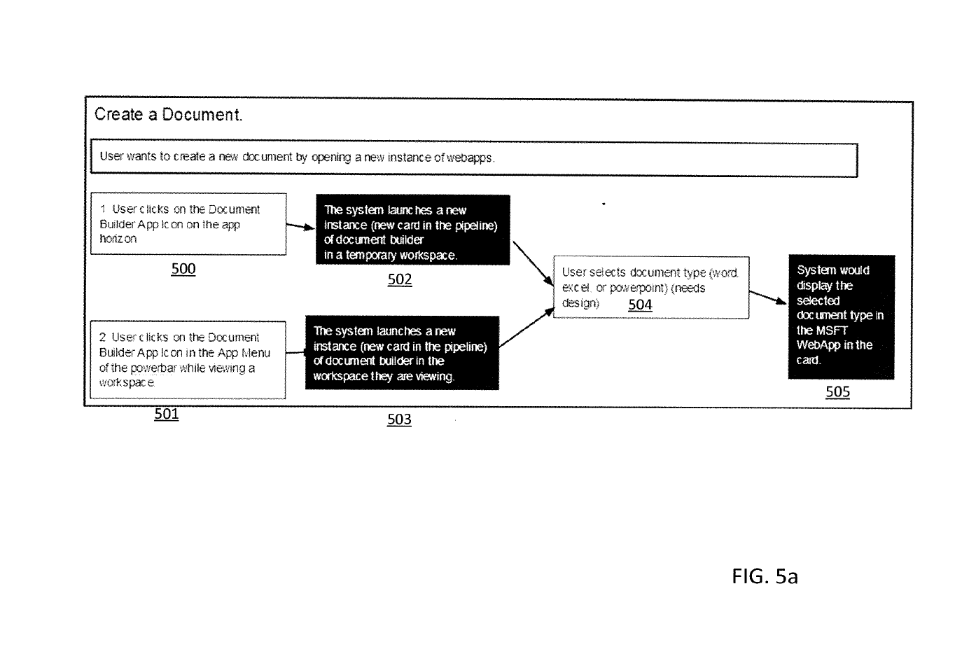

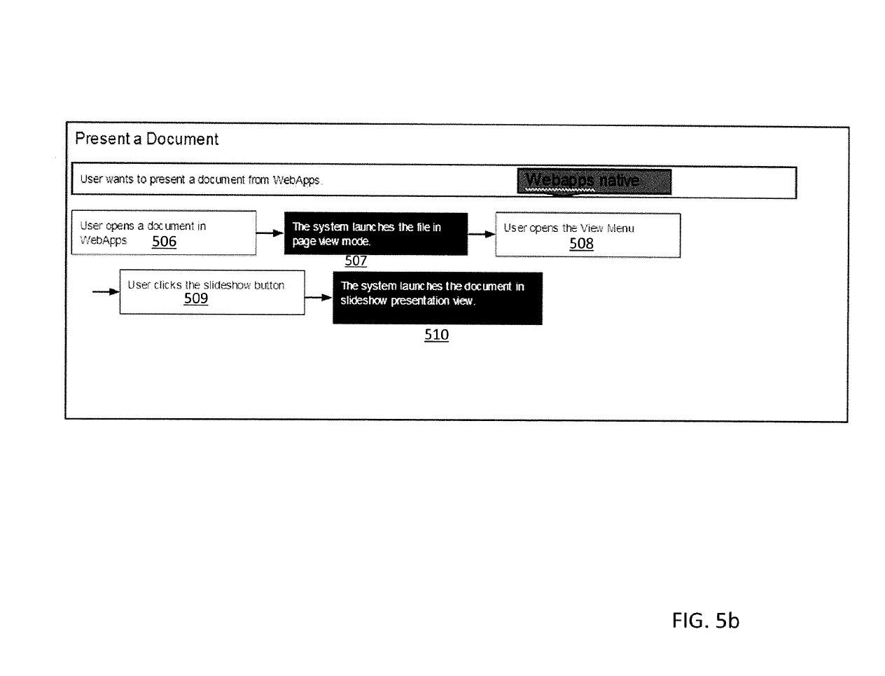

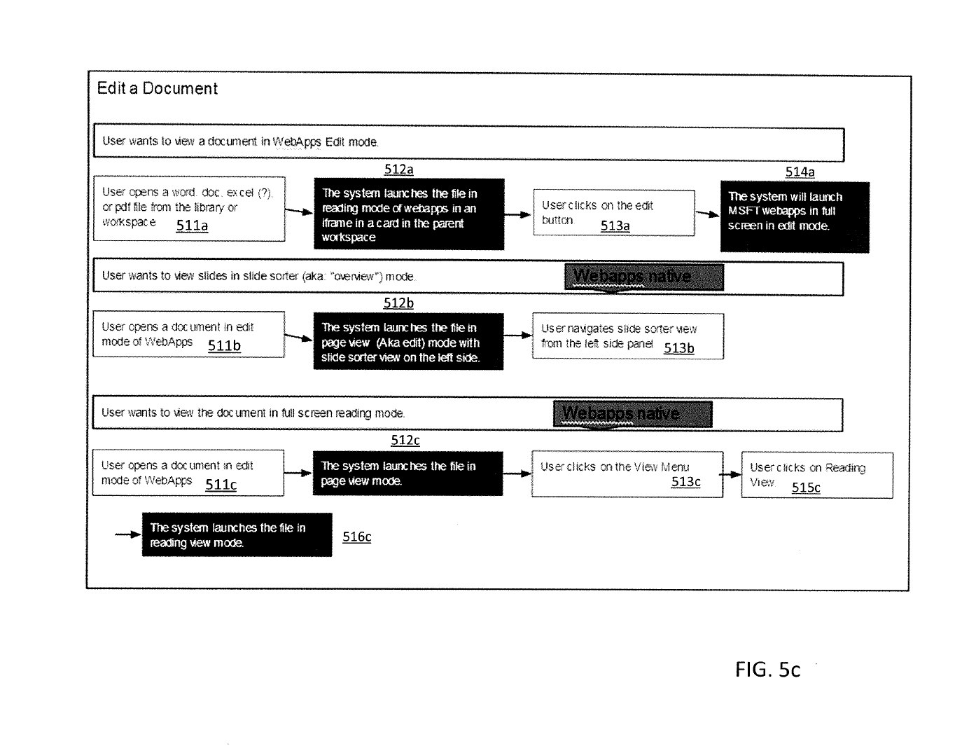

FIGS. 5a-c are flow diagrams depicting the creation of a new asset, presenting an asset, and editing an asset. Each workspace in the financial information management system may include one or more projects, or a body of work with related assets. Each asset, or document, may contain a variety of pages or slides encompassing the entirety of the document, or components of a document, such as a slide in a presentation document or a page in a text or reader document. In exemplary embodiments, the financial information management system provides for one or more views, or a way to navigate through a document. In exemplary embodiments, a page view, or component view, is the default way to view, edit, and navigate documents in a document builder. In some embodiments, the document builder may include one or more objects, which include manipulatable items such as a chart, image, shape, or text box.

FIG. 5a is flow diagram depicting a method of creating a new Asset in a financial information management system, in accordance with exemplary embodiments of the present invention. A user may create a new asset using a Document Builder Application. To initiate the creation of a new document, a user may initiate the Document Builder Application by either clicking on a Document Builder Application icon in an application horizon, discussed above (step 500) or by clicking on a Document Builder Application in the powerbar, discussed below, while viewing a workspace (step 501). If the Document Builder Application is opened from the application horizon in step 500, next, in step 502, the financial information management system will launch a new instance of a document builder in a temporary instance. Alternatively, if the Document Builder Application is opened from the powerbar while a user is viewing a Workspace in step 501, the financial information management system will next launch a new instance of a document builder in the Workspace the user is currently viewing in step 503. In step 504, the user will select a document type (such as a Microsoft Word, Excel, or Powerpoint document), and in step 505 the financial information management system will display the selected document type in a web application (such as a Microsoft Web Application).

FIG. 5b is a flow diagram depicting a method of presenting an asset in a financial information management system, in accordance with exemplary embodiments of the present invention. In step 506, a user may open an asset (such a PowerPoint application) in a web application that supports viewing/editing that asset (such as a Microsoft Web Application for PowerPoint). In step 507, the financial information management system will launch the asset into a page view mode. In step 508, the user opens the view menu. In step 509, the user clicks the slideshow button. In step 510, the financial information management system launches the document in a slideshow presentation view.

FIG. 5c is a flow diagram depicting a method of editing an asset in a financial information management system, in accordance with exemplary embodiments of the present invention. In some embodiments, a user may edit a document from three different modes: 1) a WebApps edit mode, 2) a slide sorter mode, and 3) a full screen reading mode.

To edit a document from the WebApps edit mode, in step 511a the user opens an asset from the library or workspace. In step 512a, the financial information management system launches the file in reading mode of WebApps in an iframe in a card in the parent workspace. In step 513a the user clicks on the “edit” button in the iframe. In step 514a, the financial information management system will launch the WebApp in full screen in edit mode.

To edit a document from the slide sorter, or overview, mode, in step 511b the user opens a document in edit mode of WebApps. In step 512b, the financial information management system launches the asset in page view (edit) mode with the slide sorter view on the left side panel of the display. In step 513b, the user navigates the slide sorter view from the left side panel. In some embodiments, a user can move one or more specific slides (e.g., from a PowerPoint presentation) located in the library to another PowerPoint presentation that is open in the Asset viewer. In some embodiments, a slide is added to a presentation when a user selects the slide, drags the slide, and drops the slide into the destination power point.

To edit a document from the full screen reading mode, in step 511c a user opens a document in edit mode of WebApps. In step 512c, the financial information management system launches the document in page view mode. In step 513c, the user clicks on the view menu, and in step 515c, the user clicks on “reading view.” In step 516c, the financial information management system launches the file in reading view mode.

In exemplary embodiments, a user may add content to a document by either: 1) dragging and dropping an image (flow diagram 550a), 2) dragging and dropping a text file (flow diagram 550b), 3) copying and pasting text into a file (550c), and 4) dragging and dropping slides.

In some embodiments, there may be a sources window where a user can add a source of content to a workspace. Some sources may include data and/or images. A user may add a description to the source in the source window. Additionally, a user may be allowed to remove a source from a list of sources in the sources window.

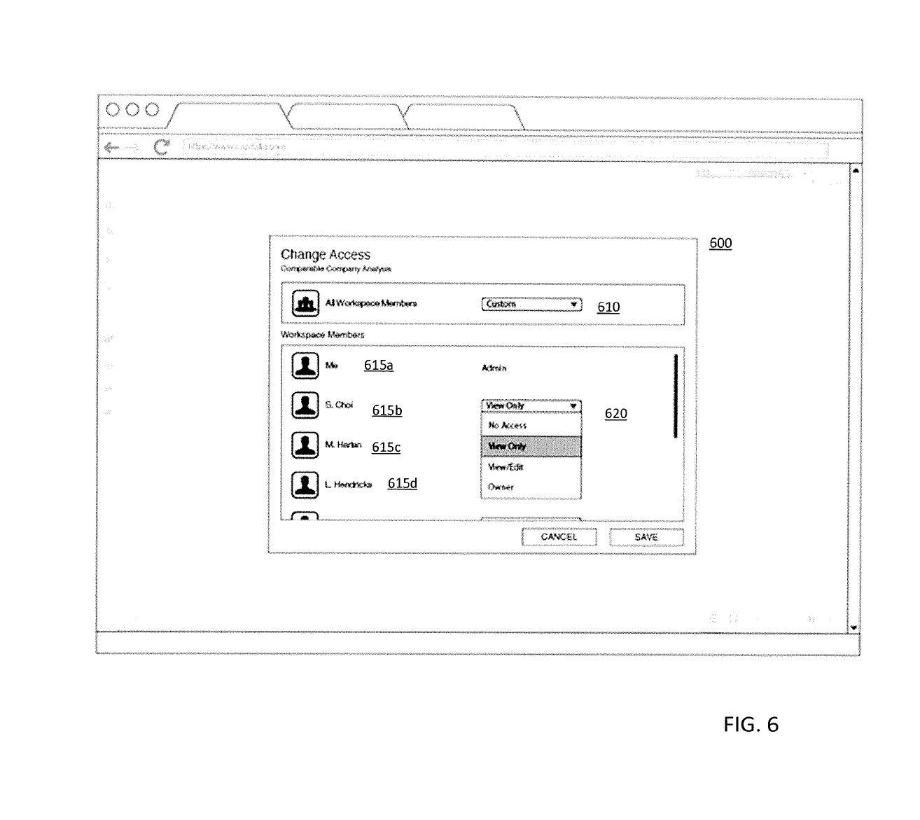

FIG. 6 is a block diagram depicting a display window in a graphical user interface with permission controls for a collaborative workspace in a financial information management system, in accordance with exemplary embodiments of the present invention. In exemplary embodiments, a member of a workspace may change access controls to certain assets. For example, if a user creates an asset in a workspace, or is an administrator to that asset, the user may restrict access to that asset to other members of the workspace. FIG. 6 depicts a change asset menu 600. Change asset menu 600 allows an administrative user to set access controls applicable to all members of the workspace, as depicted by the dropdown menu 610. Additionally, the administrative user may select access controls that are individually applicable to members 615a-d of the workspace. For example, when selecting an access control for workspace member 615b, the administrative user may be presented with a dropdown menu 620 where the administrative user may select an appropriate access control applicable to that user and asset. Those access controls may include, but are not limited to, “No Access,” “View Only,” “View/Edit,” and “Owner.”

In exemplary embodiments, the financial information management system may use a variety of permissions to control the content and/or actions that individual users may see and/or perform. For example, there may be Admin, View/Edit, View Only, and No Access permissions. With respect to assets, an Admin may be able to delete, rename, and change access levels to the asset, for example. However, a View/Edit permission may only allow a user with that permission to view or edit a document. A View permission may only allow a user with that permission to view a document, and No Access will not provide the user with that permission with any allowed actions related to the Asset.

In exemplary embodiments, the following user roles may be implemented in the financial information management system:
a) “User”—any person who has access to the system;
b) “Admin”—any person who has administrative rights on the system, and may, for example, add or delete users;
c) “Workspace Admin”—any user who has administrative rights to a particular workspace and may, for example, delete or reassign assets, remove workspace members, change the name of the workspace, and change workspace status;
d) “Workspace Member”—any user who has access to a particular workspace;
e) “Asset Admin”—any user who has administrative rights to an asset, such as deleting, renaming, or changing access levels to an asset;
f) “Asset User”—any user who has access to an asset;
g) “Organizational Library Admin”—any user who has administrative rights to an organizational library, such as adding, removing, or changing access levels of assets in the organizational library;
h) “Organization Member”—any user who has access to an organizational library;
i) “Reviewer”—any asset user who has the task of reviewing the asset, and when the asset is put into review mode, the asset is locked to view only for all participants except the review and the reviewer must submit changes and edits before editing resumes;
j) “Stakeholders”—reference point for users but does not have access to any item, e.g., no tasks and no access to the platform.

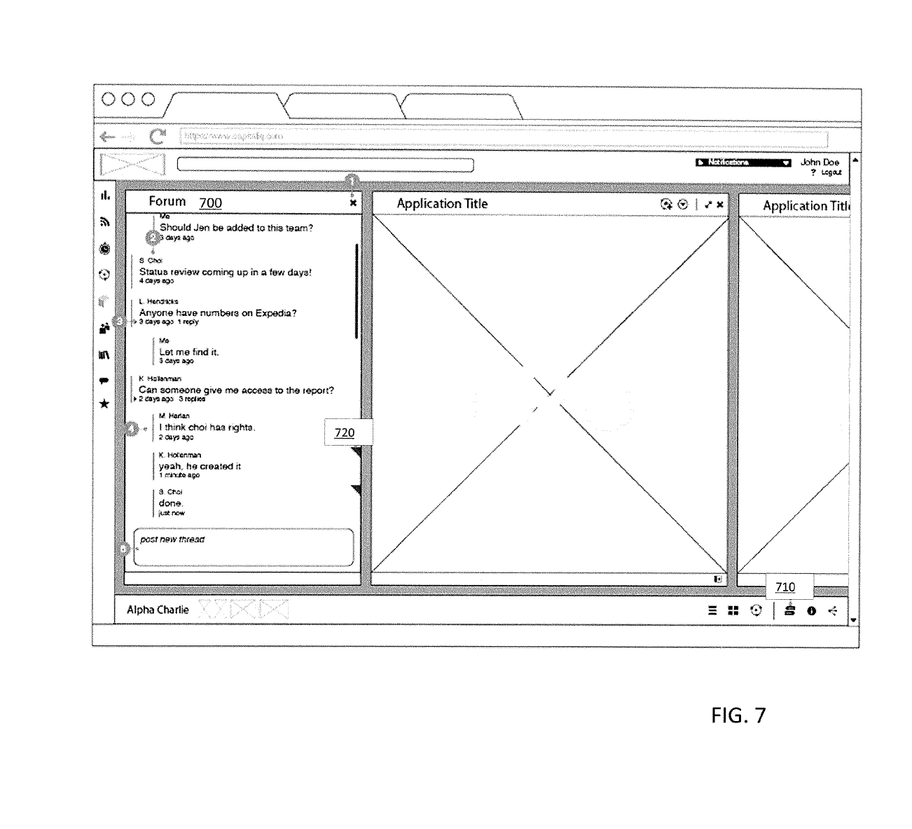

FIG. 7 is a block diagram depicting a forum in a workspace in a graphical user interface of a financial information management system, in accordance with exemplary embodiments of the present invention. In some embodiments, each workspace may have a workspace forum where workspace members may have discussions related to a workspace. The workspace forum may include forum posts, or a single message, either new or made in a reply to another post. New posts and responses to the post in the workspace forum may be presented as a forum thread.

In exemplary embodiments, each workspace has a workspace forum. In some embodiments, a user may select a forum icon 710 to view a forum window 700 applicable to the current workspace. The forum window 700 may display a chain of messages and responses to those messages, including metadata about each message such as the post-date and author. In some embodiments, a user may select an icon, such as the triangle depicted at element 710 in FIG. 7, in order to add the forum thread to the workspace as an asset, which may be saved as an asset in the workspace library.

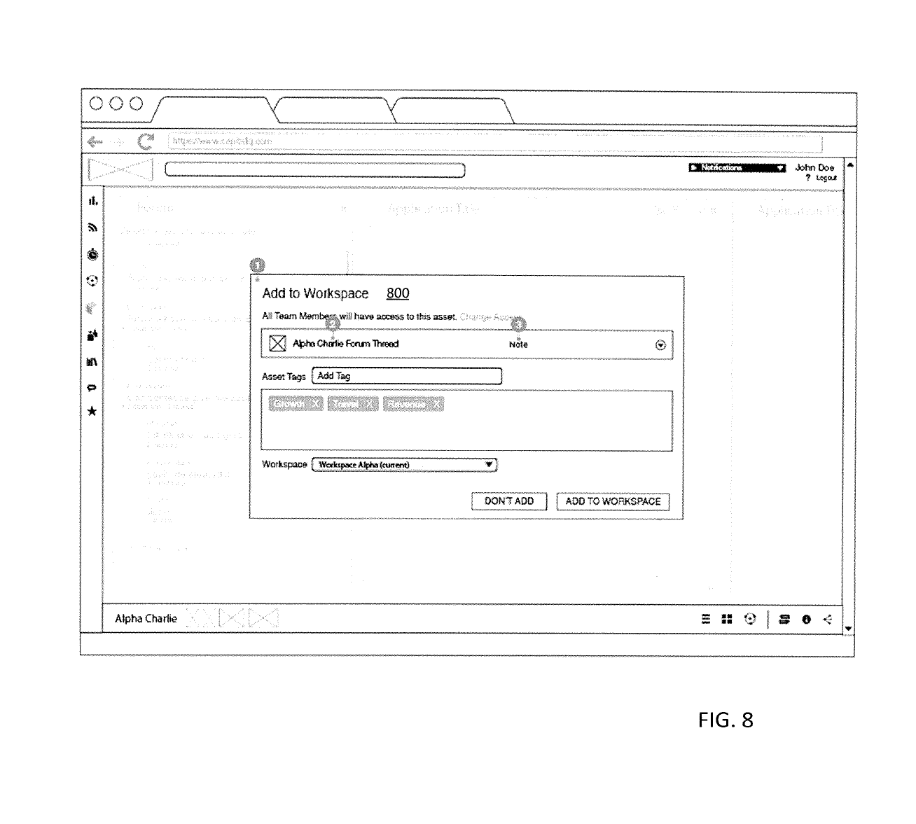

FIG. 8 is a block diagram depicting an add-to-workspace window in a graphical user interface of a financial information management system, in accordance with exemplary embodiments of the present invention. Window 800 appears when a user adds a forum as an asset to a workspace. Window 800 may provide icons, forms, and links that allow a user to, for example, change workspace members' access to the forum asset, add a note to the forum asset, add one or more tags to the forum asset, and select the workspace to which the asset will be added.

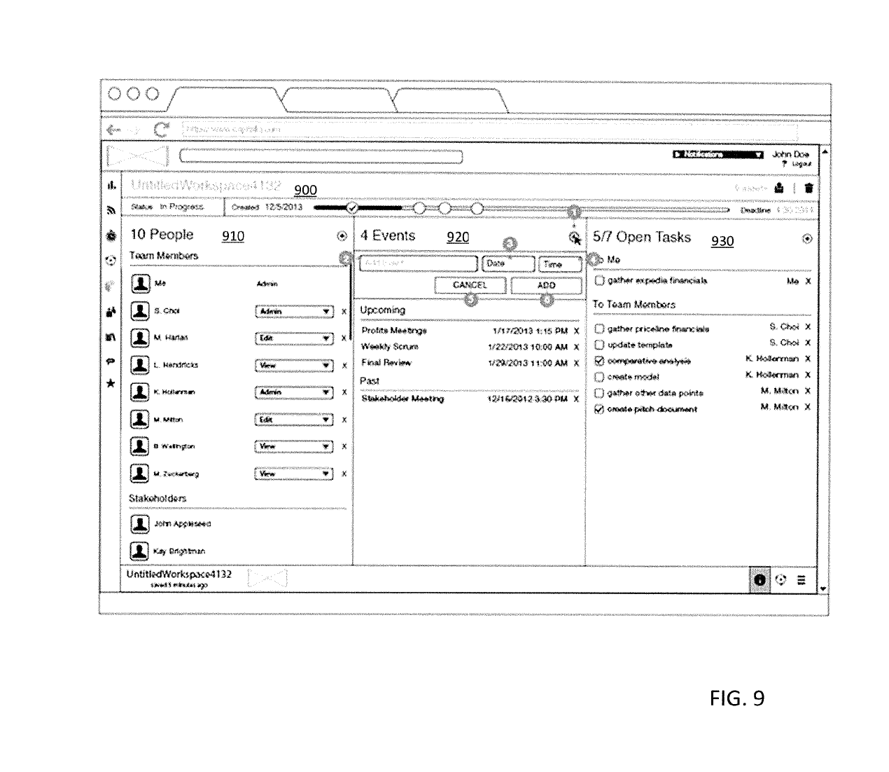

FIG. 9 is a block diagram depicting a summary view of a workspace in a graphical user interface of a financial information management system, in accordance with exemplary embodiments of the present invention. In exemplary embodiments, a user, typically an admin user of a workspace, may view an overview or summary screen of a selected workspace. FIG. 9 depicts a summary view 900 of a workspace called “UntitledWorkspace4132,” which shows the status of the workspace (“in Progress”), the creation date of the workspace (Dec. 5, 2013), and the deadline for the workspace (Apr. 30, 2014). Each of the team members or users associated with the workspace are depicted in panel 910, as well as their respective access levels to the workspace (e.g., “admin,” “edit,” “view,”). The stakeholders of the workspace are also depicted in panel 910. A second panel 920 shows a list of upcoming and past events, and provides functionality for a user to add a new event or cancel an event. Additionally, panel 930 depicts “open tasks” pertinent to the logged-in user (“Me”) and to team members associated with the workspace.

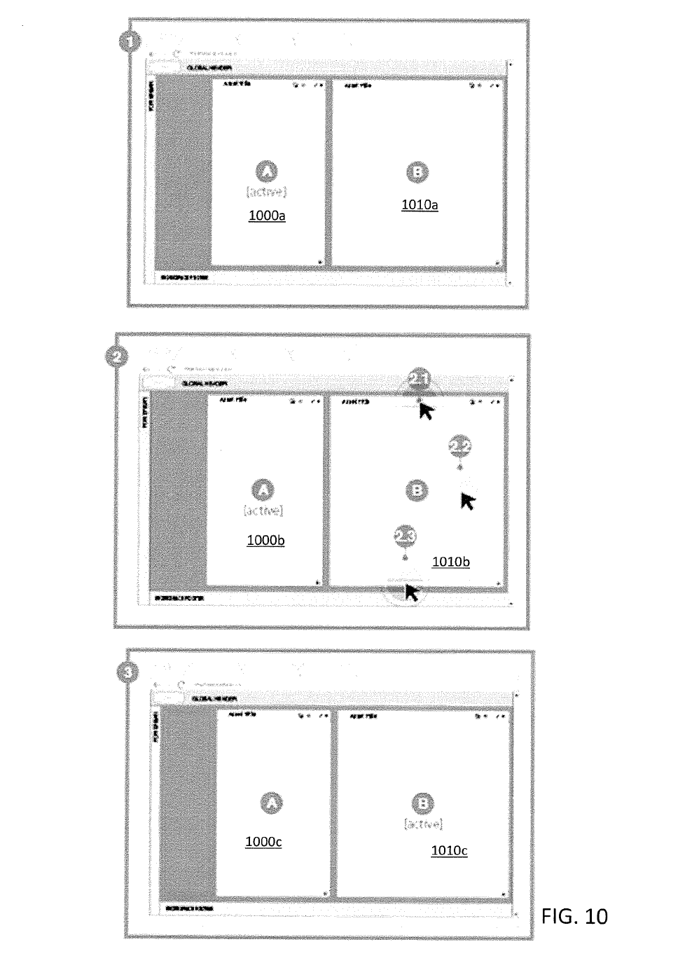

FIG. 10 is a block diagram depicting a card pipeline navigator displayed in a graphical user interface of a financial information management system, in accordance with exemplary embodiments of the present invention. In exemplary embodiments, the financial information management system has a card pipeline. In exemplary embodiments, workspace members (teams) see and interact with workspace-aware applications and data in cards. For example, any time a user selects an application from the system, the application may open in the user's “My Workspace,” or any other shared workspace that the user may belong to. Any time a user selects an asset from the system, the asset may open in that relevant workspace as a card. The card may only be viewable to that specific user within the card pipeline in the shared workspace unless the user selects “Add to Workspace.” Once the user selects “add to workspace” for the card, it will become shared with and viewable by others in the workspace.

The card pipeline may be associated with a pipeline navigator where a user can flip through all existing open cards displayed in the card pipeline. FIG. 10 depicts a card pipeline with cards A (1000a-c) and B (1010a-c) and shows how a user may navigate between the cards in the pipeline navigator. As shown in the first panel of FIG. 10, one card, card A 1000a in the pipeline, may be active while the other cards in the pipeline, such as card B 1010a, are not active. As shown in the second panel of FIG. 10, to make card B active, the user may select (e.g., by clicking) one of a number of designated areas on card B in order to make card a (1000b) inactive and card B (1010b) active. Once card B has been selected, as shown in the third panel of FIG. 3, card B 1010c becomes the active card, while card A 1000c is not active.

In some embodiments, a workspace member may link cards together so that the data and interactions contained in the cards are related. Additionally, a user may rearrange the order that the cards are displayed in the Card Pipeline. In some embodiments, the Card Pipeline may be displayed in a thumbnail view so that users can see and interact with Cards not currently visible. In some embodiments where a workspace member can close a card or break a link between cards, the system allows a user to “undo” such actions. Additionally, a user may open and work on two cards at a time, such as, for example, opening two cards in two separate windows.

In some embodiments, the system has a global chat feature so that users may initiate chats, such as text, audio, or video chats, with one or more system users. For example, there may be a global chat feature indicated by an icon in the user interface of the system, and in exemplary embodiments a global chat icon may be displayed in the powerbar tool. Global chat is a global system discussion not tied to a workspace that is made possible via a chat dialog. A user may specify and/or select other system users for global chat. In some embodiments, a user may initiate an audio conversation with one or more system users using the global chat feature. In other embodiments, a user may initiate a video conversation with one or more system users. In some embodiments, a workspace member may store selected global chat content in a workspace library to share with other members of a workspace. Additionally, a user may be able to tag global chat content that is shared with a workspace.

In some embodiments, a user may view another user's “baseball card,” which depicts information about a user, such as a picture, description, contact information, work experience, expertise, etc. A user may initiate with a person when viewing the contact information on that person's baseball card by using the global chat feature. A baseball card may contain, for example, a picture, biographical information, and contact information for a specific user of the system. Additionally, a baseball card may include the “deals” that a particular user has worked on. Thus, other collaborators using the financial information management system may browse baseball cards in order to pick an individual to work on a project based on the finance deals that user has worked on. Each deal may be displayed as a small square on the baseball card, and may include information about the deal, such as the size of the deal, the company or companies involved in the deal, etc.

Additionally, a user may initiate global chat when viewing search results, from a search run in the system, that include other system users. A user may send invitations to one or more selected system users when initiating an audio, video, or text chat. A user may accept the invitation, which then initiates the chat. The system may send a user a system notification when the user receives a new global chat invitation, or when the global chat begins. The chats, for example, text chats, may be recorded and stored in a chat archive in a library. In some embodiments, a user may be able to search the chat archive by date, content of the chat, etc. In other embodiments, a user may only receive chat search results from the chat archive for global chats in which that user was a participant. A user may also specify that a chat is only searchable by the chat participants by setting permissions on the chat. In some embodiments, a user may store global chat content in their library. Depending on whether the user marks a chat as a “favorite,” the chat may be stored indefinitely in the library or may be deleted or archived after a set period of time. Additionally, a user may be able to store global chat content in a workspace as an asset. In some embodiments, the workspace may have a workspace forum where a Workspace member may store selected global chat content. Additionally, a user may be able to tag global chat content in a Workspace.

FIG. 11 is a block diagram depicting a powerbar global navigation tool in a graphical user interface of a financial information management system, in accordance with exemplary embodiments of the present invention. In some embodiments, the system has a powerbar 1110, also alternatively called the launch bar. The powerbar has dynamic and static category buttons, each of which may be depicted with a unique image or graphic. A user may pin applications to the powerbar, which will be part of the dynamic category buttons (1130). The top toolbar in the powerbar (1120) is called the button bar. Long names that cannot fit in a single line in the powerbar panel 1110 may have ellipses at the end of the name and clicking on that name in the powerbar panel 1110 should open a tool-tip to show the entire name. When a user opens/closes the powerbar panel, the panel should slide out and slide in respectively. For example, as shown in FIG. 11, if a user selects an icon, a panel 1110 may slide out. In case of a network error when loading the items of any category in the powerbar, the message “A network error occurred. Reloading in 1 min” should be displayed with a “retry” button that allows the user to retry loading the items without having to wait a minute for the automatic reload of the items. For a particular category, once the user closes the powerbar panel, the state of the system should be preserved across sessions along with the sorting preferences. For example, if the sorting preference is “Most Recent” and the user viewed specific workspaces after closing the powerbar panel, reopening the powerbar panel for the workspaces should list the last visited workspace first. On mouse over any static category icon in the powerbar, a tool tip will display what the icon is for. These tips may include descriptions of each icon, which may include “Notifications,” “Applications,” “Workspaces,” “Asset Library,” “Favorites,” “Recent Activity,” “Contacts,” and “Conversations.” On mouse over any dynamic category icon in the powerbar, the tool tip may display the application name that was pinned.

In exemplary embodiments, the below applications/functionality are represented as icons on the powerbar, although additional icons may be added and other icons may be removed. User selection of an icon will cause the system to navigate to the one or more applications that provide the corresponding functionality within the system.

Recent Activities.

For a user with a list of recent activities, the default view of the Powerbar may be sorted by ‘Most Recent’ first. For a first time user with no recent activities list, the default view may give the user a brief overview of recent activity along with the message “You currently have no recent activity.

Workspaces.

For a user with a list of workspaces in which they are a member or an admin, the default view may be sorted by the status of the workspace with one or more workspaces in each status, thereby giving the user the opportunity to drill down into a status to view all the workspaces in that particular status. For a first time user with no workspaces, the default view may give the user a brief overview of workspaces, an option to create their first workspace along with the message “You currently have no workspaces.”

Contacts.

For a user with contacts, the default view of the contacts lists may list the favorite contacts first, followed by the organizational contacts, and then all the contacts. Each of the categories may have three contacts listed by default giving the user the opportunity to drill down into a specific category to view all the contacts in that category. In each of the individual category, the contacts are sorted by the last name in ascending order. For a first time user with no contacts, the default view may give the user a brief overview of contacts along with the message “You currently have no contacts.” The user may be given the opportunity to search for system users or other contacts to add to their list, create a new contact, or to import contacts.

Libraries.

For a user with assets available in the Libraries, the default view may categorize the assets by the library to which it belongs to namely My Library, Workspaces and Organizational with one or more assets in each category. This may give the user the opportunity to drill down into a specific category to view all the assets in that category. For a user with no assets available, the default view may give the user an overview of the Library with the opportunity to add assets.

Chat.

For a user with chat history, the default view may display all the chats by “Most Recent” and sorted by date. The user also may have the option to go into a conversation and continue it or create a new conversation. For a first time user there will no conversations displayed. The default view may give the user a brief overview of conversations with the message “you currently have no conversations.” The user may also be given the opportunity to start a new conversation.

Favorites.

For a user with items marked as favorites, the default view may display the favorites in one or more categories with one or more favorites in each of the categories. The one or more categories for the favorites may include Assets, Contacts, and/or Workspaces. The user is also given the opportunity to drill down into a specific category to view all the favorites in that category. The favorites may be displayed by “Most recent” first. This means that the favorite item in each of the category that was last accessed by the user will be displayed first. For a user with no items marked as favorites, the default view may display the overview of Favorites with the message “You currently have no favorites,”

Notifications.

For a user with items available for notifications, the default view may display all the notifications available to the user and is sorted by the “Most Recent.” The user may be given the opportunity to perform bulk activities on the notifications and also to navigate to the relevant forum relating to the specific notification. For a user with no items available for notifications, the default view may display the overview of notifications along with the message “You currently have no notifications.”

FIG. 12a is a block diagram depicting a global search in a graphical user interface of a financial information management system, in accordance with exemplary embodiments of the present invention. Global search is a utility of the financial information management system that provides users with the ability to search for data artifacts across the entire system. Global search is located in the global navigation section 1200a of the user interface and is ubiquitously available in the interface of the system. In exemplary embodiments, the search functionality supports natural language processing, and thus users may enter natural text/language queries. A series of results, or hits, to a search, may pop up dynamically as a user enters his or her query into the global search feature. In exemplary embodiments, the search results are broken out into categories, such as companies 1210a, library 1220a, people 1230a, and currently viewing 1240a. A user may see all results by selecting a “see all results” link 1250a within the search results window. Additionally, in exemplary embodiments, if a user selects a search result to open, the user will be presented with a popup menu 1260a with options for where to open the search result (e.g., in an entity viewer, powerbar, asset viewer, or application).

FIG. 12b is a block diagram depicting results from a global search in a graphical user interface of a financial information management system, in accordance with exemplary embodiments of the present invention. FIG. 12b depicts a global search utility 1200b in a global navigation panel of the financial information management system. Additionally, FIG. 12b shows the “all results” hits 1250b from a user-entered query for “Google.” Alternatively, a user may drill down the results by category, such as by companies, 1210b, library, 1220b, people, 1230b, currently viewing 1240b, as well as other categories such as workspaces and public or proprietary financial data (e.g., S&P Capital IQ Content). Additionally, the global search feature may present “related searches” 1270b and “recent searches” 1280b options to, for example, assist users in formulating a search.

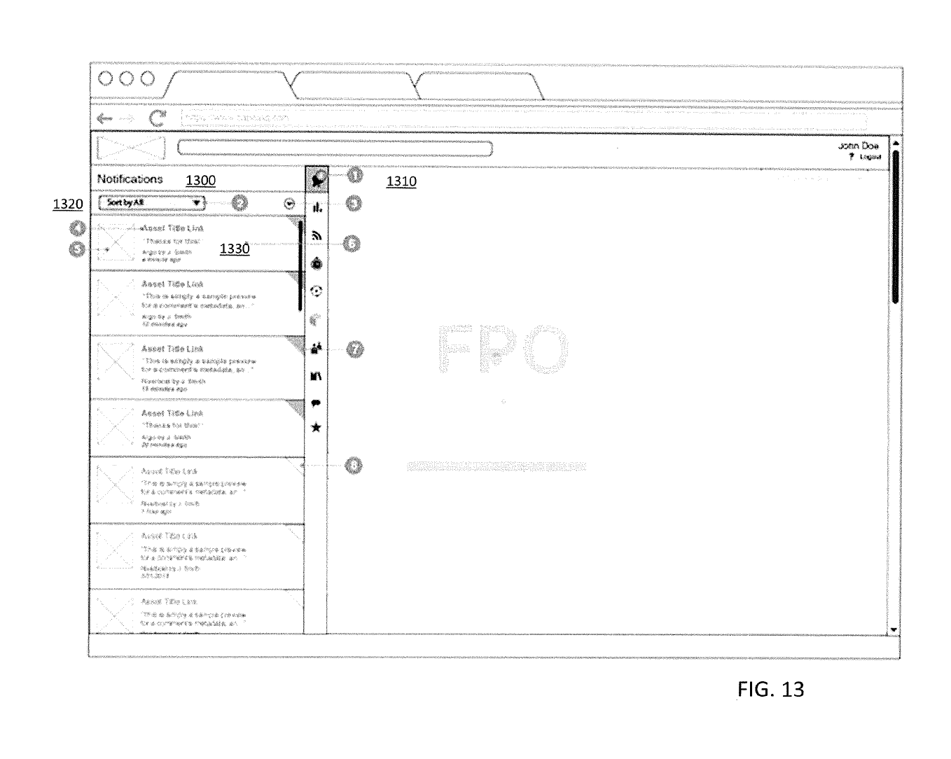

FIG. 13 is a block diagram depicting notifications in a graphical user interface of a financial information management system, in accordance with exemplary embodiments of the present invention. Notifications may be displayed in a notifications menu 1300 in the financial information management system interface. In exemplary embodiments, a user may select a notifications icon 1310 from the powerbar, and the notifications menu 1320 may appear in a slide out panel from the powerbar. The notifications menu 1300 may display any current notifications (1330), the number of notifications (count), and additional information about each notification, such as a comment, author of a comment, and name of an asset associated with a comment. Notifications may be designated as unread, read, etc. In some embodiments, a new notification will be displayed to indicate a request for a chat from another user.

In exemplary embodiments, each notification 1330 may have a title link that displays the name of the item or asset to which the notification is related to. Clicking on the link may lead the user to the relevant area (e.g., a workspace, forum, application, global chat, etc.). Sometimes an avatar of the user related to the action/notification is displayed. Various metadata may also be displayed with the notification, including a related user's name and timestamp, the workspace or system area in which the action that prompted the notification was performed, and a notification preview. Notifications may be sorted, by, for example, the workspaces that the notifications belong to.

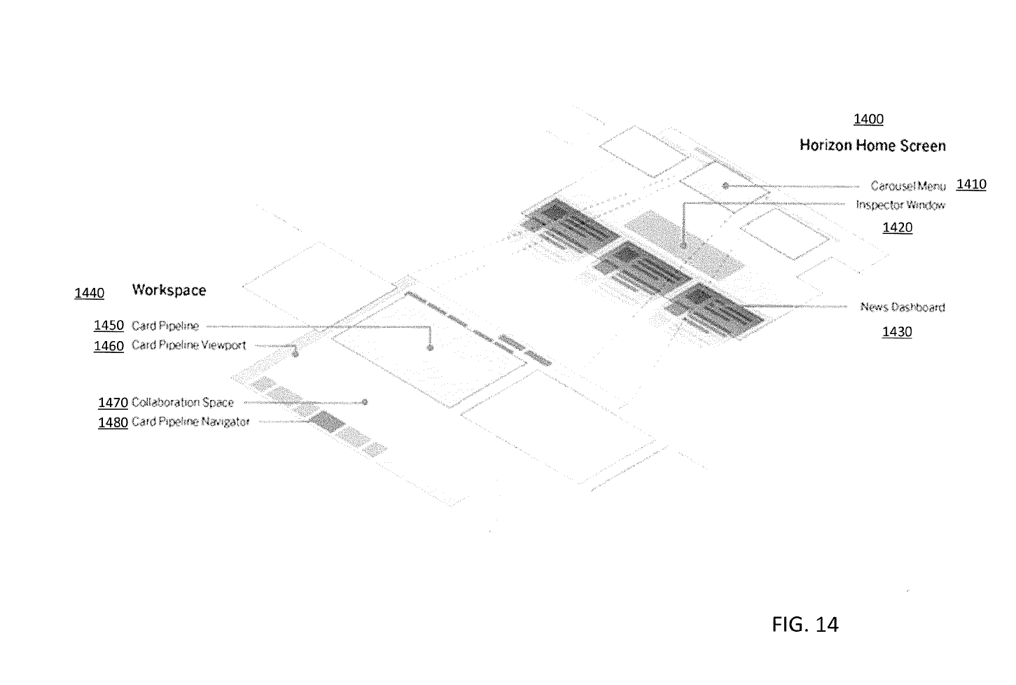

FIG. 14 is a block diagram depicting a workspace framework in a graphical user interface of a financial information management system, in accordance with exemplary embodiments of the present invention. As explained in detail above, the financial information management system may have a horizon landing page 1400 (e.g., depicted in FIGS. 3a-c), or home screen. The horizon home screen 1400 may provide a carousel menu 1410 that displays a plurality of informational items, such as workspaces, applications, market information, etc. In exemplary embodiments, an inspector window 1420 containing detailed information about a selected or highlighted informational item in the carousel menu 1410 may be displayed. In exemplary embodiments, a news dashboard may be displayed on the horizon home screen 1400 to display dynamic news content to a user.

As described in detail above, a card pipeline 1450 may be displayed within a workspace 1440. In exemplary embodiments, a variety of navigational tools are provided to allow a user to switch through elements of the card pipeline 1450, including a card pipeline navigator 1480 and a card pipeline viewport 1460 (depicted in a powerbar). Additionally, in exemplary embodiments, each workspace has a collaboration space 1470, which may display informational items about team members, assets, and projects associated with that workspace.

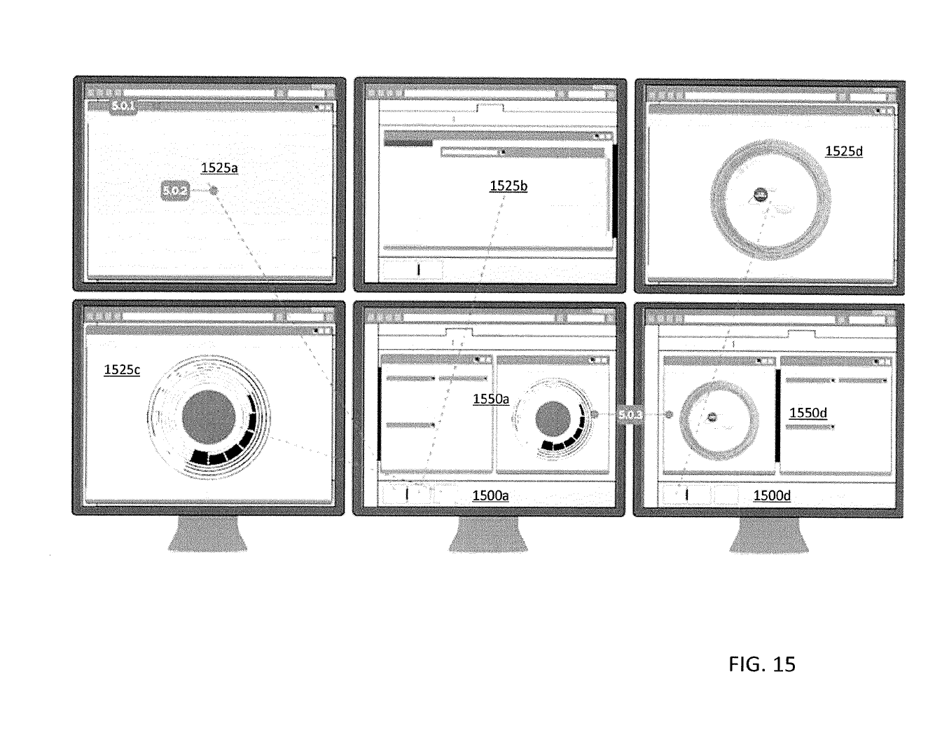

FIG. 15 is a block diagram depicting cards in a graphical user interface of a financial information management system, in accordance with exemplary embodiments of the present invention. In exemplary embodiments, a card pipeline navigator (1500a,d) may allow a user to navigate through one or more cards (1525a-d) in a card navigator pipeline (1550a,d). In exemplary embodiments, when a user opens a card asset, a card pipeline navigator (1500a, d) is displayed in the bottom of the screen generated by the user interface. The card pipeline navigator (1500a, b) may contain thumbnail images of one or more cards (1525a-d) that are linked to the opened card. A user may navigate through a set of linked cards in the card pipeline as explained above in connection with FIG. 10. In exemplary embodiments, when a user selects a card from the card pipeline navigator (1500a, b), the selected card (1525a-d) will display in a full screen mode across the user interface display.

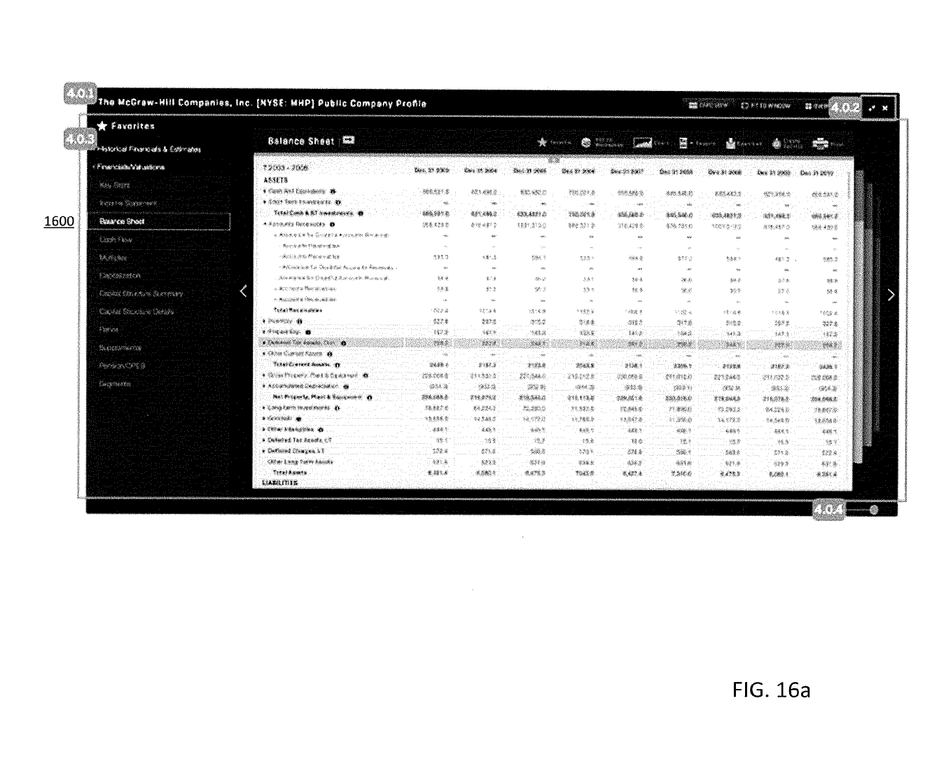

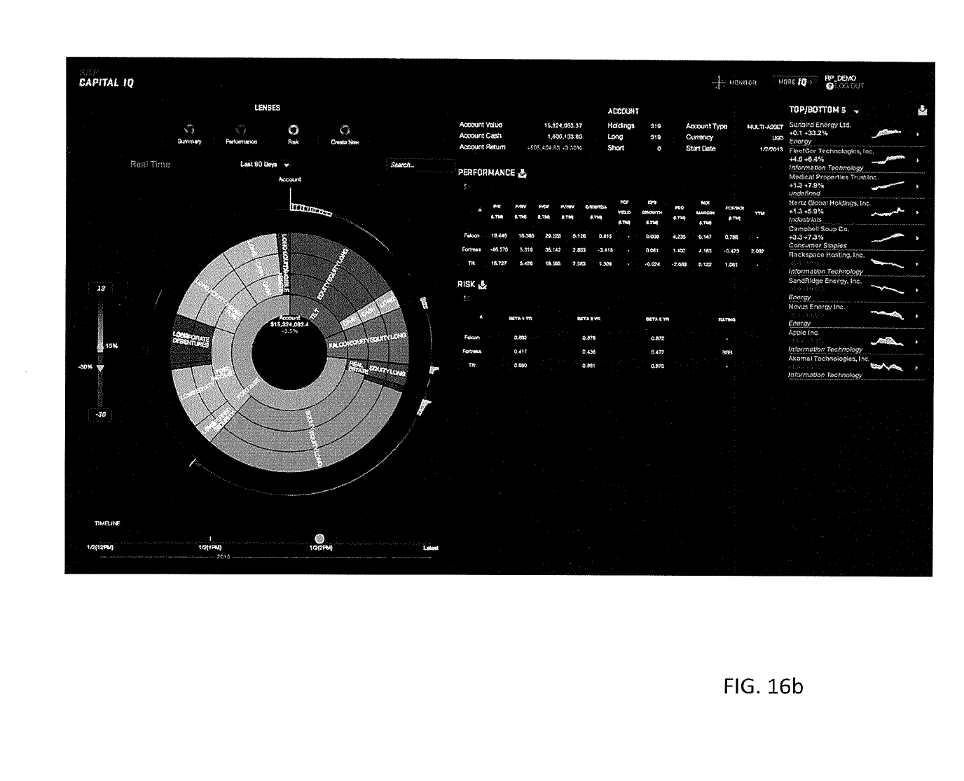

In exemplary embodiments, cards may display a plurality of informational items in different formats. For example, as explained above, baseball cards may be used to display informational items about an individual's profile. Additionally, cards may display informational items or datasets about particular financial assets, entities, or events. For example, cards 1525a and 1525b may depict a tearsheet for a financial entity, described in further detail in connection with FIG. 16a. Additionally, cards 1525c and 1525d may display a plurality of informational items about a financial asset or portfolio as part of a “hellos” display, described in further detail in connection with FIG. 16b.

FIG. 16a is a graphical workspace display depicting a Card with a public company profile, in accordance with exemplary embodiments of the present invention. In exemplary embodiments, cards may depict a tearsheet, or a summary page for a financial entity. In some embodiments, the tearsheet may be fully displayed on the display device, e.g., so that a user does not have to scroll through the tearsheet in order to view pertinent information. In some embodiments, a menu 1600 may be provided that allows a user to view different informational items about a particular financial entity as part of a tearsheet. For example, FIG. 16 depicts a tearsheet showing informational items pertaining to an entity's balance sheet, and menu 1600 offers options to a user for the system to display informational items about the entity's income statement, cash flow, capitalization, etc.

FIG. 16b is a graphical workspace display depicting a portfolio card with a hellos display, in accordance with exemplary embodiments of the present invention. In some embodiments, the system may have a hellos display. Helios is a visual display of the proportion of new developments (news, transactions, etc. relating to financial activities) available for the user to view. Helios refers to a circular graph that changes dynamically based on how a user wishes to view or analyze a portfolio. For example, the hellos display may contain a plurality of clickable asset classes, industries, etc. associated with an asset that a user can select. For example, if the hellos display relates to a portfolio for American and Latin American regions, and a user clicks on a more specific region, such as a country, the portfolio will further break the details down into smaller regions in the hellos display.

In exemplary embodiments, the performance of assets in the portfolio are depicted using various shapes and colors in the hellos display. In some embodiments, the portfolio information for a specific user may be obtained from a server, and in other embodiments, a user may be able to import their portfolios directly into the financial information management system.

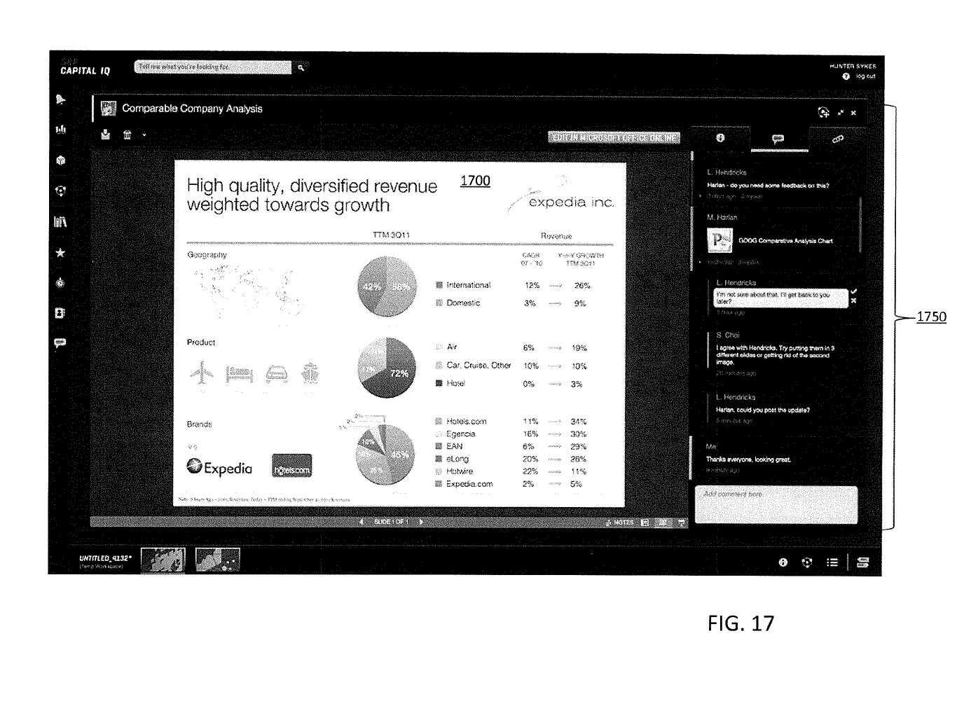

FIG. 17 is a graphical workspace display depicting a commenting feature for an asset, in accordance with exemplary embodiments of the present invention. A comment is a note associated with an asset at the document level. Additionally, there may be a component content, which is a note associated with an asset at the component (e.g., page/slide) level. Additionally, an object comment may be a note associated with an asset at the component object level, such as a specific selection inside a page or slide (e.g., a graph, chart, etc.).

FIG. 17 displays a slide of an asset 1700. A panel 1750 on the right side of the display includes a series of comments about asset 1700. Each comment may display the author, date, and other metadata about the comment. Additionally, each comment may be associated with one or more reply comments, which in exemplary embodiments are displayed in a nested fashion underneath the original comment. In exemplary embodiments, a text box also may appear in comment panel 1750 that allows a user to add a new comment about the asset 1700.

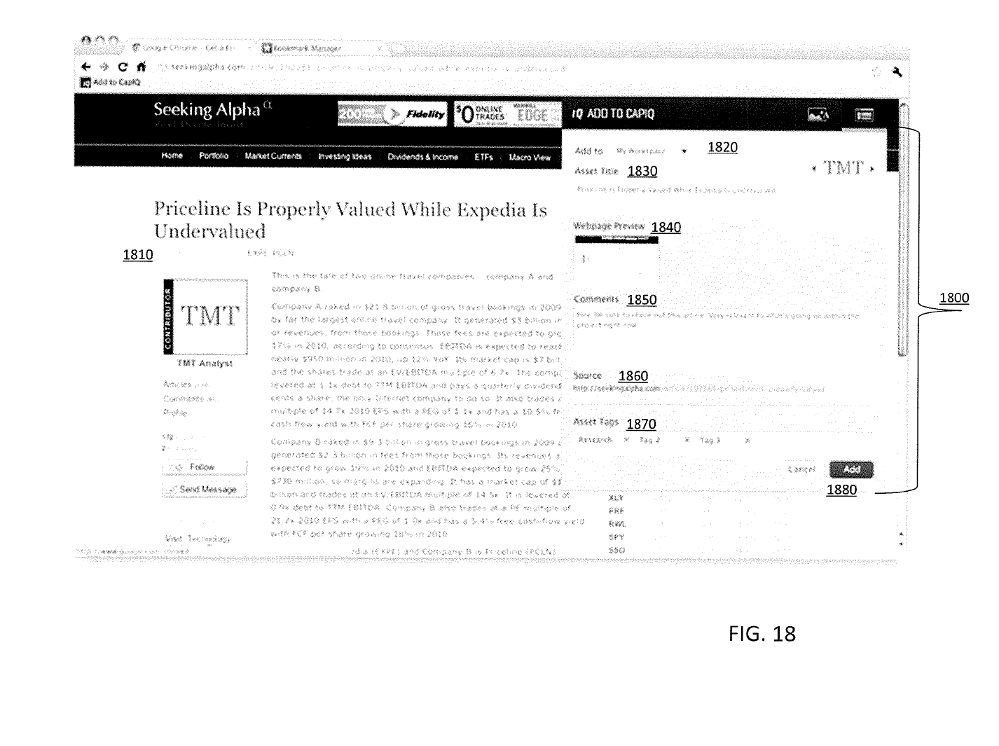

FIG. 18 is a graphical workspace display depicting the importation of an asset, in accordance with exemplary embodiments of the present invention. Users may have the ability to import and tag content from external websites, devices, and systems to a workspace within the system, and share that content with other users. In exemplary embodiment, data from sources external to the financial information management system, such as websites and local documents, may be captured and stored in the library of the financial information management system using a standard plug-in component 1800. For example, a Microsoft 365 plug-in component may be integrated with the financial information management system in order to allow a user to import local Microsoft document assets into the system.

FIG. 18 displays a plug-in component 1800 that may be used to capture data from a currently viewed website 1810. In exemplary embodiments, a user may select a button in their web browser to open the plug in component 1800. The plug-in component may allow a user to specify where in the system a user wants to store the asset 1820 (e.g., in a workspace or library), provide a title for an asset 1830, type in comments for the asset 1850, and tag the asset 1870 with informative metadata. Additionally, the plug-in component 1800 may provide a preview thumbnail image of the selected asset 1840 to be added to the system and may designate the source 1860 (e.g., webpage) of where the asset originated.

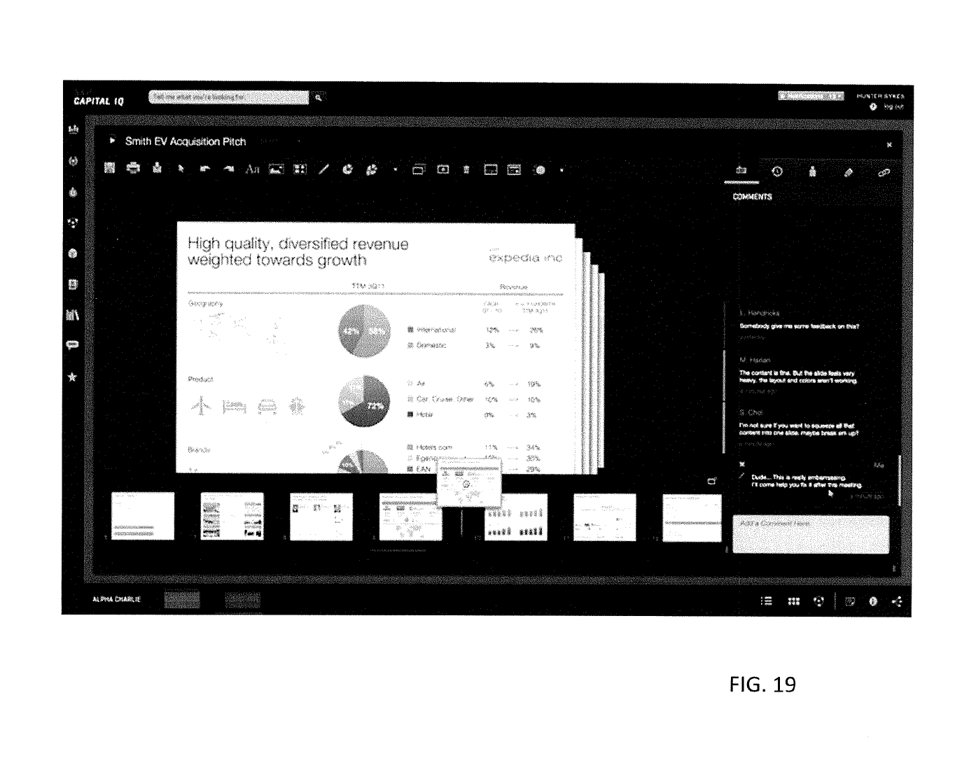

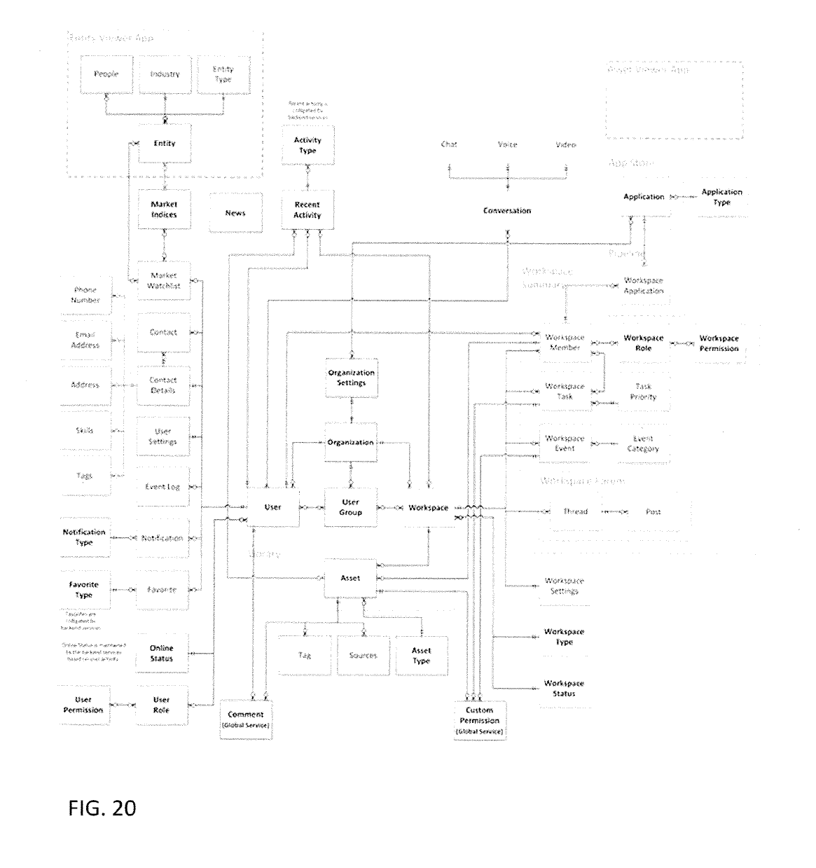

FIG. 19 is a graphical workspace display depicting a visual trace feature of a financial information management system, in accordance with exemplary embodiments of the present invention. In some embodiments, the system may have a visual trace feature that allows a user to audit the assets on a slide in a presentation, as shown in FIG. 20. For example, when a user creates a new asset, such as a power point presentation, the user may set a visual trace function so that users may see where information depicted in the asset originated from, who modified it, etc. In exemplary embodiments, the trace view links other assets to a document builder document.

FIG. 20 is a block diagram of a logical data model for a financial information management system, in accordance with exemplary embodiments of the present invention. The Web OS Logical Data Model highlights the key data elements and their relationship with other data elements in the system and how it relates to the user interface (UI). Boxes with dashed lines indicate where UI concepts are represented. For instance, a user library is represented in the logical data model as a set of assets owned by the user. The top left and right boxes indicate the entity viewer and asset viewer applications, respectively. These two applications overlap into the Web OS functionality.

A unique URL may be defined for each resource in the system. A URL could reference a list of resources or, by specifying an ID, can reference a specific resource. In exemplary embodiments, all IDs for each resource type used in the system may be globally unique. This approach is for security purposes and also to allow for cleaner and streamlined URLs since the services provided by the system may not require an id for each node in the URL. For example, the list of notifications associated to a user with id 12345 may be represented by a URL like https://[domain]:[port]/[version]/users/12345/notifications but, if the authenticated user is user 12345, the URL https://[domain]:[port]/[version]/notifications can be used to get all notifications readable by that user. Either way the notifications list is requested, the URL to a notification with the id 54321 associated to a specific user does not need the user's information in the URL; all it needs is the notification's id https://[domain]:[port]/[version]/notifications/5432. All URLs may be logical URLs and not physical URLs. This means that there does not have to be a physical static document associated to the URL. When the services layer receives a URL it would interpret it based on the operation the client requested.

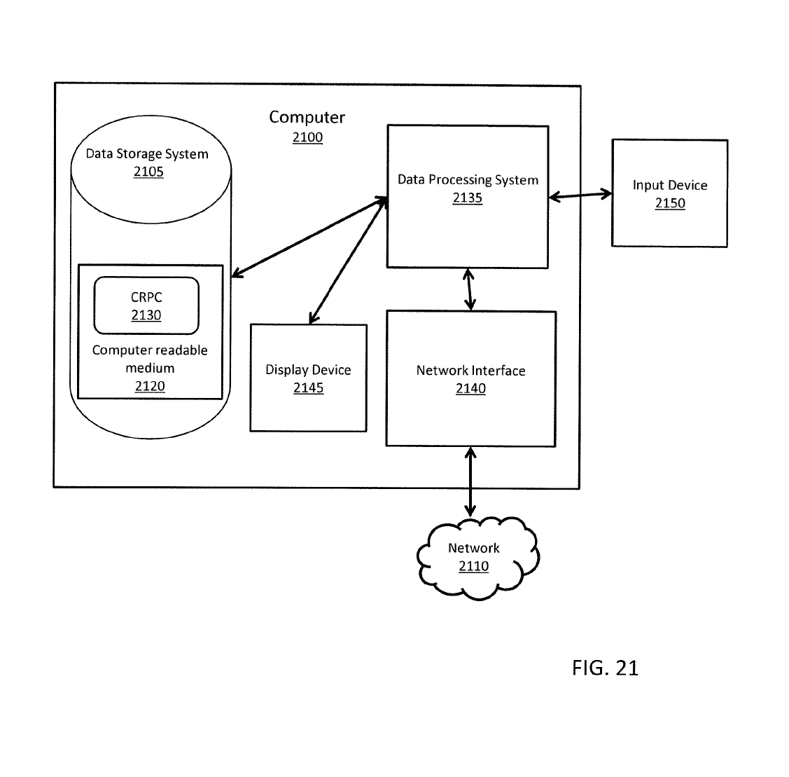

FIG. 21 is a block diagram depicting a computing device in accordance with exemplary embodiments of the present invention. In some embodiments, the system 100 may be implemented on one or more computers (or servers) 2100 that is connected to a communications network. As shown in FIG. 21, computer 2100 may include a data processing system 2135. In some embodiments, data processing system 2135 may include any number of computer processors or central processing units (CPUs), any number of which may include one or more processing cores. In some embodiments, any of the processing cores may be physical or logical.

Computer 2100 also includes network interface 2140 for receiving messages (e.g., messages transmitted from a client) and transmitting messages over network 2110, and a data storage system 2105, which may include one or more computer-readable mediums. The computer-readable mediums may include any number of persistent storage devices (e.g., magnetic disk drives, solid state storage, etc.) and/or transient memory devices (e.g., Random Access Memory).

Computer 2100 may also include a display device 2145. The display device 2145 may be, for example, a monitor, touch screen, LCD screen, or any physical or virtual interface to display content. In some embodiments, the financial information management system 100 user interface may be displayed on display device 2145 where the invention is implemented on computer 2100. The data processing system 2135 of computer 2100 may be connected to the display device 2145, such as, for example, through a wireless or physical connection, and be configured to display the financial information management system user interface and the illustrative workspace windows described above. In some embodiments, display device 2145 is coupled to an input device 2150, such as where computer 2100 is connected to an LCD screen display device 2145 configured to receive input from a user.

The data processing system 2135 of computer 2100 may also be connected to an input device 2150, which may be, for example, a keyboard, touchscreen, mouse, or voice capture device for voice recognition. In some embodiments, input device 2150 may be connected to computer 2100 via a network 2110 and a network interface 2140, and in other embodiments the input device 2150 may be directly connected to the processing system 2135 of computer 2100, such as via a wire, cable, or wireless connection.

In embodiments where data processing system 2135 includes a microprocessor, a financial information management system program product may be provided. Such a computer program product may include computer readable program code 2130, which implements a computer program, stored on a computer readable medium 2120. Computer readable medium 2120 may include magnetic media (e.g., a hard disk), optical media (e.g., a DVD), memory devices (e.g., random access memory), etc. In some embodiments, computer readable program code 2130 is configured such that, when executed by data processing system 2135, code 2130 causes the processing system to perform steps and functionality described above.

The financial information management system and methods according to the present invention may be implemented in various platforms. The implementation examples disclosed herein are for example only, and are not intended to further limit the invention. A person of skill in the art can appreciate that the invention may be implemented in a variety of platforms.

The disclosed financial information management system implements a variety of design principles to guide the user interface. The interface is designed to enhance collaboration by allowing users to share data quickly via, for example, the workspaces. The system interface may also use progressive disclosure of features to help users focus on the task at hand. The system allows users to see instant feedback, such as via notifications, comments, tags, versioning control of assets, etc. The system is designed to work anywhere on any type of computing or mobile devices. Additionally, the system allows for user connections and collaboration via features like the baseball cards, global chat, workspaces, etc. that are particularly suited for financial service professionals.

1. A computer-implemented method to generate a horizon view of a plurality of financial information objects comprising:
arranging, on a computer, the plurality of interactive financial information objects along a horizon carousel, wherein the financial information objects comprise at least one or more of market data, portfolio data, applications, and workspaces;
displaying, on a display device of the computer, the horizon carousel and the financial information objects along a horizontal plane, wherein the horizontal plane is horizontally movable in response to inputs from an input device; and
generating, on the computer, an inspector window, wherein the inspector window displays, on the display device of the computer, additional information about a currently active interactive financial information object.

2. A system comprising:
a processor;
a display device coupled to said processor;
one or more non-transitory computer memories coupled to said processor storing program instructions executable by said processor to implement a financial information management system configured to:
display, one the display device, an interactive workspace, wherein the workspace comprises one or more users and one or more assets associated with the one or more users;
access a workspace library, wherein the workspace library comprises the one or more assets;
visually depict, on the display device, the one or more assets in the workspace library as icons in a workspace canvas of the workspace, wherein the icons are arranged either as a list or in an orbit around the one or more users;
display, on the display device, notifications relating to the at least one of the one or more users and the one or more assets; and,
enforce access permissions associated with the one or more users and the one or more assets.

3. A computer-implemented method in a financial information management system comprising:
accessing, on a computer, one or more cards, wherein a card is the logical grouping and visual display of informational items associated with a person, financial entity, asset, event, and/or portfolio;
arranging, on the computer, the one or more cards along a card pipeline, wherein the card pipeline is situated on a horizontal plane that is horizontally movable in response to inputs from an input device; and,
displaying, on the computer, an active card from the one or more cards on the card pipeline, wherein the information in the active card changes dynamically in response to user inputs.
